(19) United States
(12) Patent Application Publication
(10) Pub. No.: US 2012/0124655 A1
(43) Pub. Date: May 17, 2012

(54) Apparatus for connecting a human key identification to objects and content or identification, tracking, delivery, advertising, and marketing

(76) Inventors: David Valin, Flushing, NY (US); Alex Socolof, Briancliff Manor, NY (US)

(21) Appl. No.: 13/357,029

(22) Filed: Jan. 24, 2012

Related U.S. Application Data
(63) Continuation of application No. 12/860,936, filed on Aug. 23, 2010, now abandoned.
Application No. 12/860,936 is a continuation of application No. 12/830,344, filed on Jul. 4, 2010.

(51) Int. Cl. H04L 9/32; G06Q 20/40

(52) U.S. Cl. 726/7; 705/76; 726/6

(57) ABSTRACT

An apparatus for connecting a human key identification to objects and content or identification, tracking, delivery, advertising, and marketing. An Independent Clearing House Agent (ICHA) server is connected to a human key server. The human key server is connected to a translation server and universal virtual world (UVW) server for the management of a plurality of methods and mechanism integrally working as one system. A virtual world airport (VWA) server is connected to a Mobile, Handheld, and Independent Device Application Development (MHIDAD) server which in turn communicates with an illumination transformer audio video manager interactive server transmitter (ITAVMIST which communicates with a Virtual Cash Virtual Currency (VCVC) server. The authentication unit also creating identification data; and sending to verification; a match combined with 9 out of 17 positive point evaluations returns, via an Internet connection to the mobile device.

### CROSS REFERENCE TO RELATED APPLICATIONS

This application claims priority from and is a Continuation of U.S. patent application Ser. No. 12/860,936, entitled “Apparatus for connecting Protect Anything human key identification mechanism to objects, content, and virtual currency for identification, tracking, delivery, advertising and marketing”, filed on Aug. 23, 2010, which is incorporated by reference in its entirety for all purposes as if fully set forth herein.

U.S. patent application Ser. No. 12/860,936 is a Continuation of U.S. patent application Ser. No. 12/830,344 entitled “Apparatus for secure recording and transformation of images to light for identification, and audio visual projection spatial point targeted area” filed on Jul. 4, 2010

### FEDERALLY SPONSORED RESEARCH

Not Applicable

### TECHNICAL FIELD OF THE INVENTION

The present invention generally relates to a method for indemnifying and protecting information. More specifically the present invention relates a method of identifying and authenticating a user's identity and transmitting protected information to the identified and authenticated user.

### BACKGROUND OF THE INVENTION

The ways in which someone may be authenticated fall into three categories, based on what are known as the factors of authentication: something a user know, something a user have, or something a user are. Each authentication factor covers a range of elements used to authenticate or verify a person's identity prior to being granted access, approving a transaction request, signing a document or other work product, granting authority to others, and establishing a chain of authority.

Security research has determined that for a positive identification, elements from at least two, and preferably all three, factors be verified. The three factors (classes) and some of elements of each factor are: the ownership factors: something the user has (e.g., wrist band, ID card, security token, software token, phone, or cell phone); the knowledge factors: something the user knows (e.g., a password, pass phrase, or personal identification number (PIN), challenge response (the user must answer a question)); and the inherence factors: something the user is or does (e.g., fingerprint, retinal pattern, DNA sequence (there are assorted definitions of what is sufficient), signature, face, voice, unique bio-electric signals, or other biometric identifier).

When elements representing two factors are required for identification, the term two-factor authentication is applied. e.g. a bankcard (something the user has) and a PIN (something the user knows). Business networks may require users to provide a password (knowledge factor) and a pseudorandom number from a security token (ownership factor). Access to a very high security system might require a mantrap screening of height, weight, facial, and fingerprint checks (several inherence factor elements) plus a PIN and a day code (knowledge factor elements), but this is still a two-factor authentication.

Counterfeit products are often offered to consumers as being authentic. Counterfeit consumer goods such as electronics, music, apparel, and counterfeit medications have been sold as being legitimate. Efforts to control the supply chain and educate consumers to evaluate the packaging and labeling help ensure that authentic products are sold and used. Even security printing on packages, labels, and nameplates, however, is subject to counterfeiting.

One familiar use of authentication and authorization is access control. A computer system that is supposed to be used only by those authorized must attempt to detect and exclude the unauthorized. Access to it is therefore usually controlled by insisting on an authentication procedure to establish with some degree of confidence the identity of the user, granting privileges established for that identity. Common examples of access control involving authentication include: Asking for photoID when a contractor first arrives at a house to perform work; Using captcha as a means of asserting that a user is a human being and not a computer program; A computer program using a blind credential to authenticate to another program; Logging in to a computer; Using a confirmation E-mail to verify ownership of an e-mail address; Using an Internet banking system; and Withdrawing cash from an ATM.

In some cases, ease of access is balanced against the strictness of access checks. For example, the credit card network does not require a personal identification number for authentication of the claimed identity; and a small transaction usually does not even require a signature of the authenticated person for proof of authorization of the transaction. The security of the system is maintained by limiting distribution of credit card numbers, and by the threat of punishment for fraud.

Security experts argue that it is impossible to prove the identity of a computer user with absolute certainty. It is only possible to apply one or more tests which, if passed, have been previously declared to be sufficient to proceed. The problem is to determine which tests are sufficient, and many such are inadequate. Any given test can be spoofed one way or another, with varying degrees of difficulty.

Therefore, what is needed is a method and apparatus for proving identity of a computer or other electronic device user by applying one or more tests which are sufficient to proceed with allowing access and which are adequate in certainty of identity of a user.

### DEFINITIONS

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“Netbot” is an automated or semi-automated tool that can carry out repetitive and mundane tasks.

“NFC” is an acronym for “Near Field Communication” which allows for simplified transactions, data exchange, and wireless connections between two devices in proximity to each other, usually by no more than a few centimeters. NFC is expected to become a widely used system for making payments by smartphone in the United States. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than using the actual credit card.

A “PortalBot” is an automatic aggregator of specific semantic, keyword, or human key information from targeted internet web portals, for the purpose of finding, searching, identifying, and managing intellectual property, copyrighted material, or media in a network like the Internet or world wide web (WWW).

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

### SUMMARY OF THE INVENTION

The current present invention is an apparatus for connecting a human key identification to objects and content or identification, tracking, delivery, advertising, and marketing. A plurality mechanisms integrally working as one system is explained. An Independent Clearing House Agent (ICHA) server is connected to a human key server. The human key server is connected to a translation server and universal virtual world (UVW) server for the management of a plurality of methods and mechanism integrally working as one system. A virtual world airport (VWA) server is connected to a Mobile, Handheld, and Independent Device Application Development (MHIDAD) server which in turn communicates with an illumination transformer audio video manager interactive server transmitter (ITAVMIST which communicates with a Virtual Cash Virtual Currency (VCVC) server. The authentication unit also creating identification data; and sending to verification; a match combined with 9 out of 17 positive point evaluations returns, via an Internet connection to the mobile device.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 is a flow chart illustrating a plurality mechanisms integrally working as one system;

FIG. 2 is a flow chart illustrating a doctor exchange server system in Virtual and Non Virtual Worlds;

FIG. 3 is a flow chart illustrating the doctor exchange system in a virtual and non-virtual world;

FIG. 4 is a flow chart illustrating the doctor exchange server system in Virtual and Non Virtual World;

FIGS. 5-6 illustrate the CODEFA apparatus used in the human key apparatus in Virtual and Non Virtual Worlds;

FIG. 7 is a flow chart illustrating the human key e Hardware with 3D Human Video Audio Stereo Viewing and Recording devices in Virtual and Non Virtual Worlds;

FIG. 8 illustrates the human key connected to an authentication unit front input hardware device in Virtual and Non Virtual World;

FIG. 9 is a flow chart illustrating the human key connected to a process server in Virtual and Non Virtual World;

FIG. 10 shows the human key connected to a hardware device with an algorithm for analyzing and processing in Virtual and Non Virtual Worlds;

FIG. 11 shows the human key connected to a first Email hardware apparatus in Virtual and Non Virtual Worlds;

FIG. 12 shows the human key connected to a secure email hardware device in Virtual and Non Virtual World;

FIG. 13 shows the human key connected to Email hardware in Virtual and Non Virtual World;

FIG. 14 is a first, A processor, used in the apparatus of the present invention;

FIG. 15 is a first, B processor, used in the apparatus of the present invention;

FIG. 16 is a first, C processor, used in the apparatus of the present invention;

FIG. 17 is a first, D processor, used in the apparatus of the present invention;

FIG. 18 is a first, E processor, used in the apparatus of the present invention;

FIG. 19 is a first, F processor, used in the apparatus of the present invention;

FIG. 20 is a first, G processor, used in the apparatus of the present invention;

FIG. 21 is a first, H processor, used in the apparatus of the present invention;

FIG. 22 is a first, I processor, used in the apparatus of the present invention;

FIG. 23 is a first, J processor, used in the apparatus of the present invention;

FIG. 24 is a first, K processor, used in the apparatus of the present invention;

FIG. 25 is a first, L processor, used in the apparatus of the present invention;

FIG. 26 is a first, N processor, used in the apparatus of the present invention;

FIG. 27 is a first, O processor, used in the apparatus of the present invention;

FIG. 28 is a first, Q processor, used in the apparatus of the present invention;

FIG. 29 is a first, M processor, used in the apparatus of the present invention;

FIG. 30 is a first, U processor, used in the apparatus of the present invention;

FIG. 31 is a first, X processor, used in the apparatus of the present invention;

FIG. 32 is a first, V processor, used in the apparatus of the present invention;

FIG. 33 is a first, W processor, used in the apparatus of the present invention;

FIG. 34 is a first, R processor, used in the apparatus of the present invention;

FIG. 35 is a first, S processor, used in the apparatus of the present invention;

FIG. 36 is a first, T processor, used in the apparatus of the present invention;

FIG. 37 illustrates the human key Object Identification Unit Verification Processor device in Virtual and Non Virtual World;

FIG. 38 illustrates a human key Spatial Point Targeting System Processor Mechanism in Virtual and Non Virtual Worlds;

FIG. 39 illustrates the human key Virtual Augmented Reality System Processor in Virtual and Non Virtual Worlds;

FIG. 40 shows the illumination transformer audio video manager interactive server transmitter (ITAVMIST-IL-UHD) Ultra High Definition Multi Spectrum Camera Mechanism in Virtual and Non Virtual Worlds;

FIG. 41 shows the illumination transformer audio video manager interactive server transmitter (ITAVMIST) connected wireless or wired to a free standing laser transmitter array mechanisms in Virtual and Non Virtual Worlds; and

FIG. 42 shows the Laser communication Transceiver Transmission and Receiver device of the present invention.

### DETAILED DESCRIPTION OF THE INVENTION

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

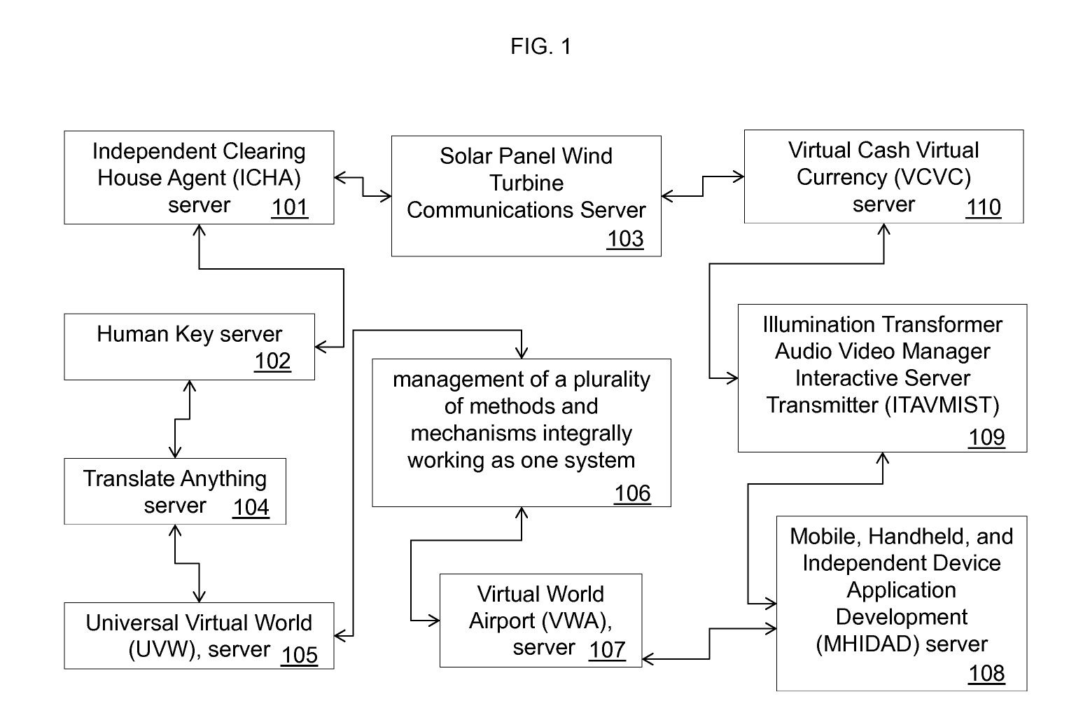

The current present invention is an apparatus for connecting a human key identification to objects and content or identification, tracking, delivery, advertising, and marketing. Now referring to FIG. 1, a plurality mechanisms integrally working as one system is explained. An Independent Clearing House Agent (ICHA) server 101 is connected to a human key server 102 and a Solar Panel Wind Turbine Communications Server 103. The human key server 102 is connected to a translation server 104 and universal virtual world (UVW) server 105 for the management of a plurality of methods and mechanism integrally working as one system 106. A virtual world airport (VWA) server 107 is connected to a Mobile, Handheld, and Independent Device Application Development (MHIDAD) server 108 which in turn communicates with an illumination transformer audio video manager interactive server transmitter (ITAVMIST 109 which communicates with a Virtual Cash Virtual Currency (VCVC) server 110.

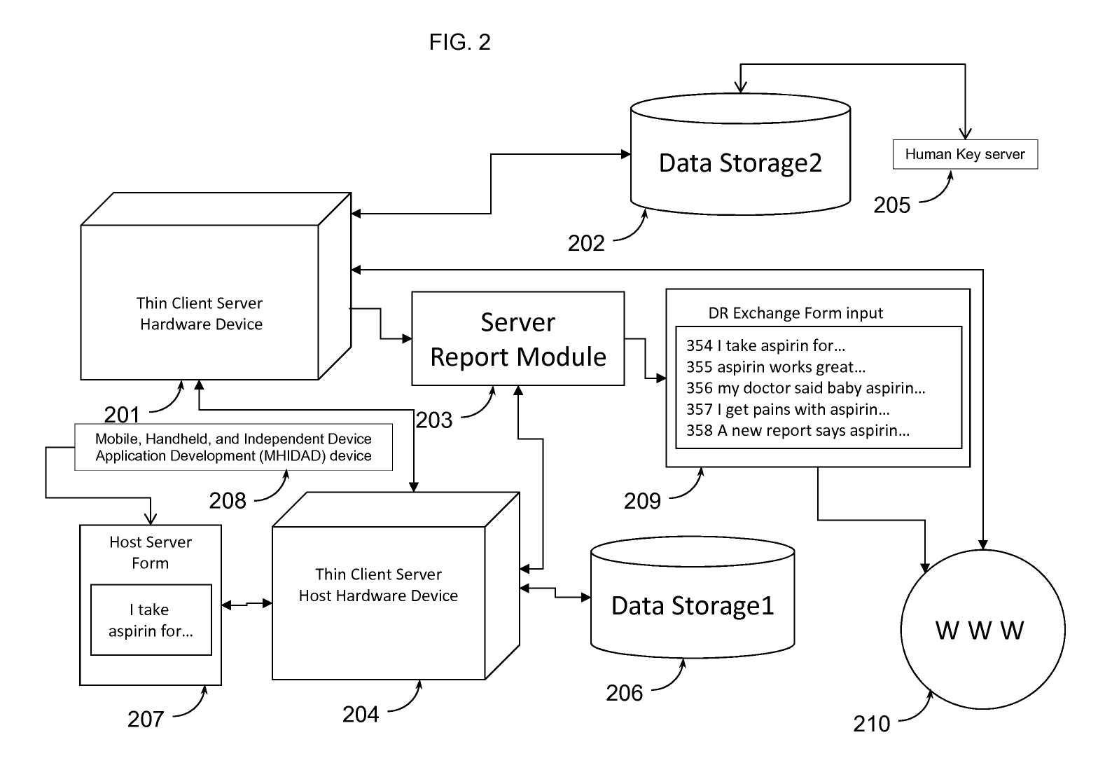

FIG. 2 is a flow chart illustrating a doctor exchange server system in Virtual and Non Virtual Worlds. A first thin client server hardware device 201 is provided for intelligent free roaming which communicates with a second data storage device 202 that interacts with a human key server 205, a server report module 203, and a thin client server host hardware device 204. The thin client server host hardware device 204 interact with a first data storage 206 and use a host server form 207 to gather input from a mobile, handheld, and independent device application development (MHIDAD) device 208. A doctor exchange input form 209 is used by the server report module 203 to publish information to the world wide web (WWW) 210.

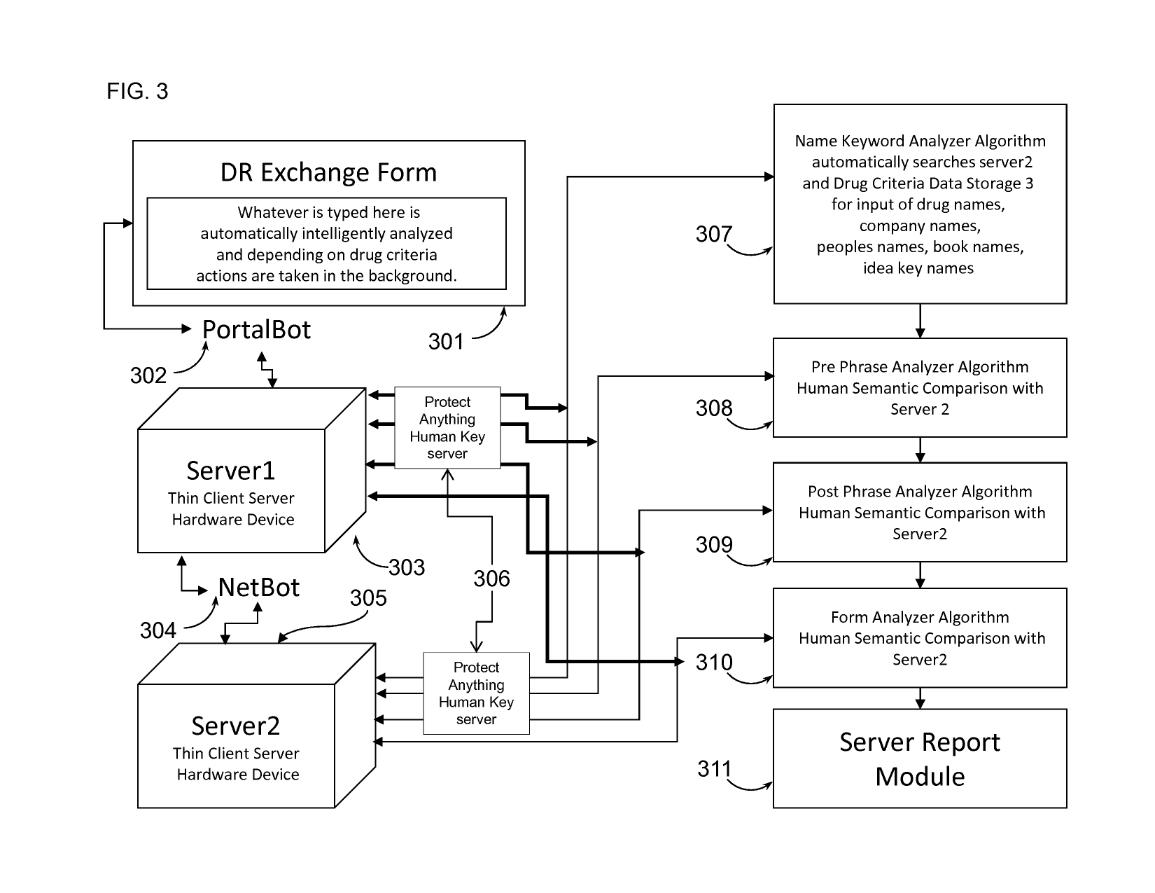

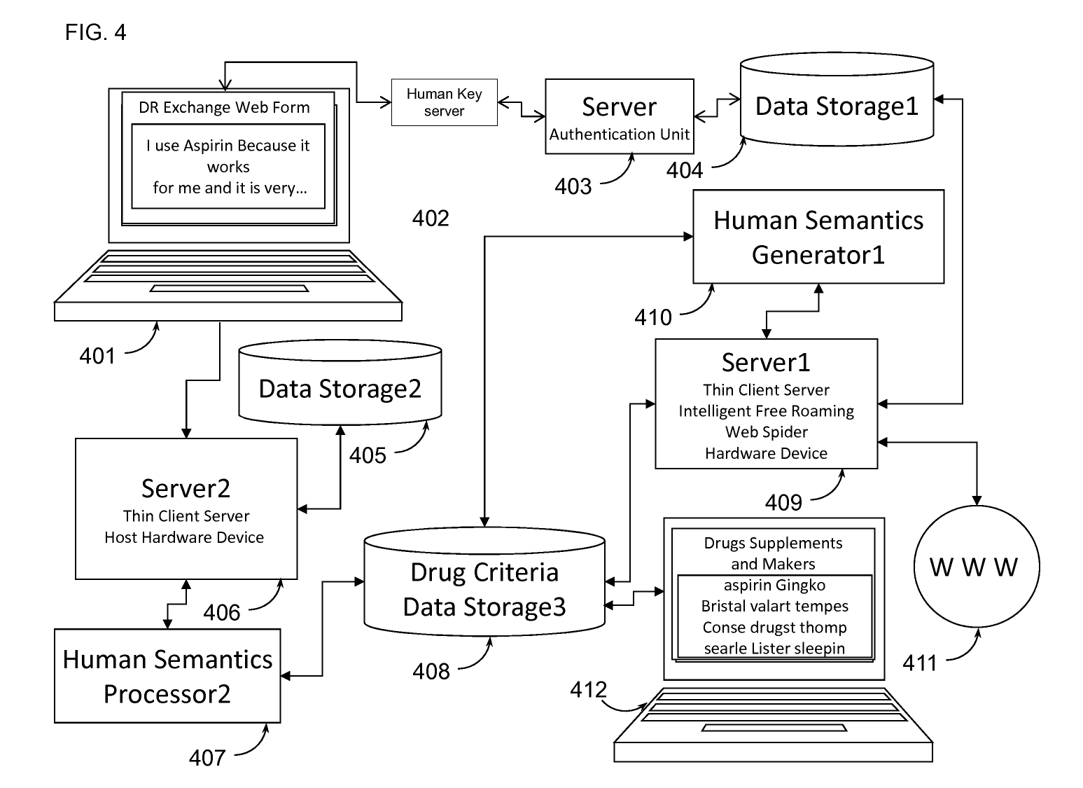

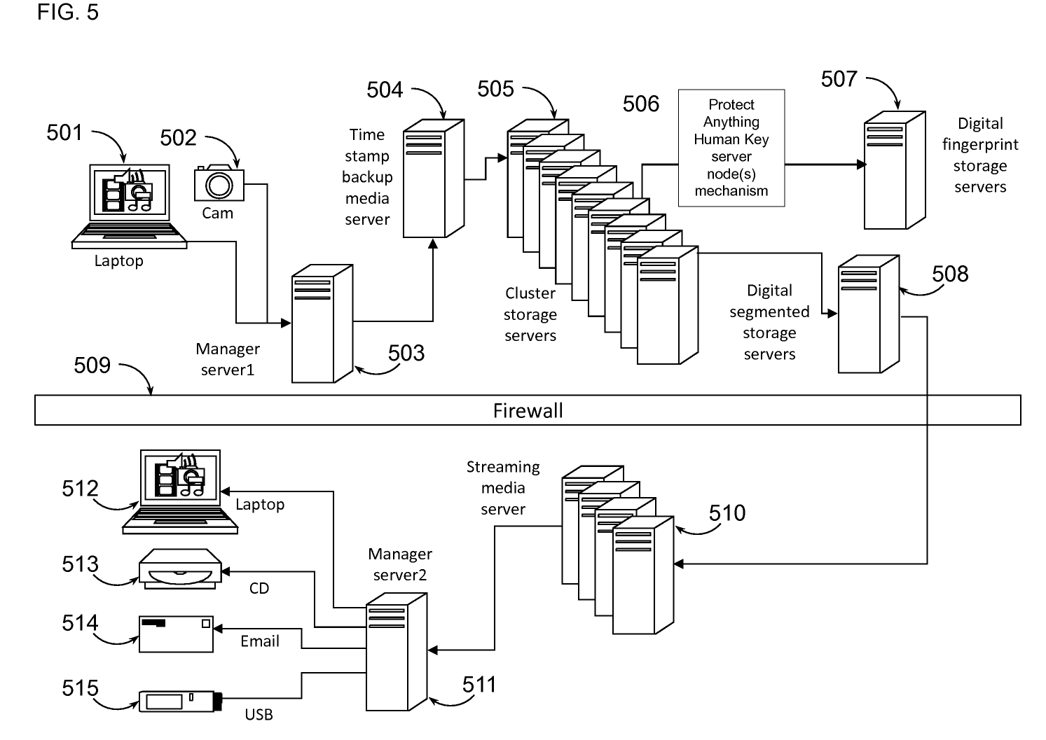

Now referring to FIG. 3, an exchange form 301 gathers input and sends it to a first thin client server 303 via a portalbot 302. A second thin client server 305 uses a netbot 304 to send human key server information 306 to the first thin client server 303. Both the first thin client server 303 and second thin client server 305 receiving information from the human key server information 306. The human key server information 306 sends and receives information to and from a servers performing various comparisons such as: a Name Keyword Analyzer Algorithm automatically searching the second thin client server 305 and Drug Criteria Data Storage 3 for input of drug names, company names, people's names, book names, and idea key names 307; a Pre Phrase Analyzer Algorithm Human Semantic Comparison 308 with the second thin client server 305; a Post Phrase Analyzer Algorithm Human Semantic Comparison 309 with second thin client server 305; a Form Analyzer Algorithm Human Semantic Comparison 310 with second thin client server 305; and a server report module 311.

A mobile device such as a lap top is used to access the doctor exchange form 401 which uses a human key server 402 and authentication server 403 to access a first data storage 404 and confirm user identity. From the mobile device such as a lap top is used to access the doctor exchange form 401 a user can access a second data storage 405 via a second thin client server 406 using a second human semantics process server 407 to access a drug criteria data storage 408 which communicates with a first human semantics generator 410, and a first thin client server 409. The first thin client server 409 can provide a connection to the world wide web 411 while the drug criteria data storage 408 may be access by a lap top is used to access the doctor exchange form 401 or a second lap top 412.

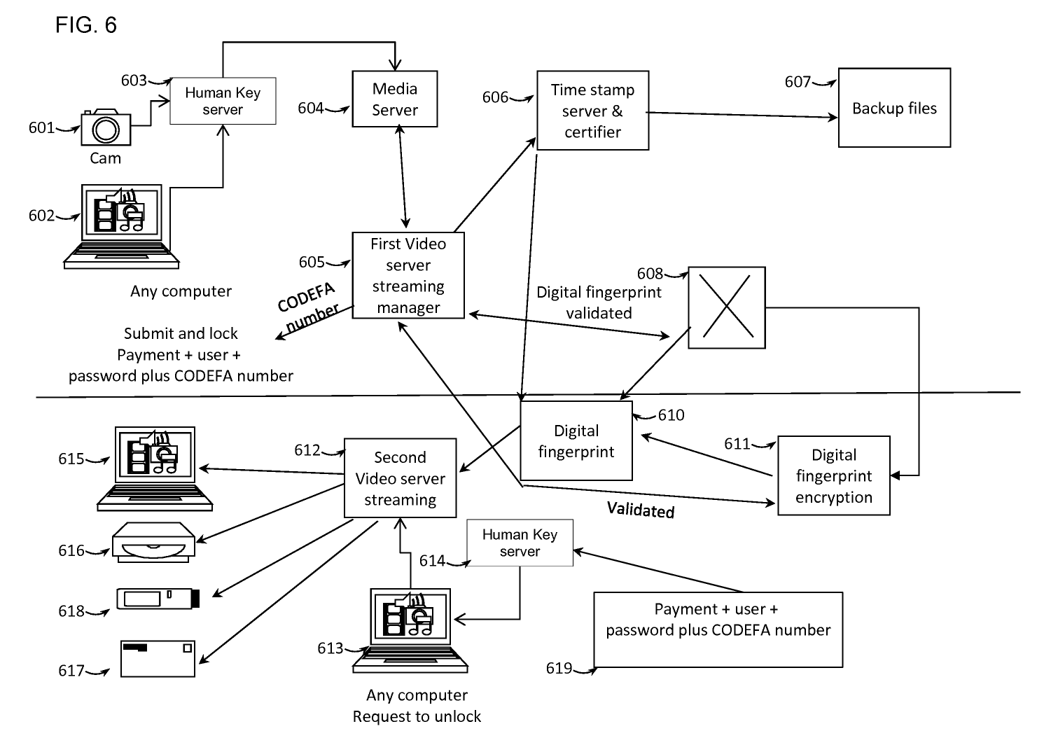

Now referring to FIG. 6, illustrates the CODEFA used the human key apparatus in Virtual and Non Virtual World. A laptop 501 or cam 502 is used to provide input to a first manager server 503 which communicates with a time stamp back up media server 504 and a cluster of storage servers 505 that have access to a human key server 506 and digital fingerprint storage servers 507 for verification. A digital segmented storage server 508 provides access across a firewall 509 to streaming media servers 510. The streaming media servers 510 are controlled by a manager server 511 that provides output via a laptop 512, CD 513, email 514, and USB 515.

A cam 601 or computer 602 accessed a human key server 603 which in turn accesses a media server 604 which accesses a first video server stream manager 605 which in turn sends information to a time stamp server and certifier 606 which is backed up a stored 607. A digital fingerprint validation information is provided by accesses to the first video server stream manager 605 to a digital storage encryption server 608 which validates a digital fingerprint form stored prints 610 and encrypted prints 611 and sends the validation the first video server stream manager 605 which in turn generates a CODEFA number for submission. The CODEFA number is good for one use then a new number must be retrieved. A second video streaming server 612 sends information to a computer 615, CD 616, Email 617, and USB 618 which is accessed by any computer 613 to request to unlock, which is verified by the human key server 614 which confirms a payment, user, password, and CODEFA number 619.

Still referring to FIG. 6, FIG. 6 relates to the taking of information from media files, and transforming that information to identification information utilizing processing to and from four element areas: 1. Initial Segmented encryption (registration of media objects or files); 2. Digital storage of Segmented encryption; 3. Digital fingerprint creation (transformation of the segmented encryption to a digital fingerprint); and 4. Digital fingerprint validated, or validation. This is the actual initial process for creating an identification of media, this later on can be combined with the human key, so that objects can be attached to the human key. These functions are also demonstrated in by name in later figure for CODEFA which is the identification registration encryption decryption and function for registering media objects, video, audio, files, images in the system. When one combines identification of media objects and human objects then they can accomplish the purpose of this patent.

Also the APS active pixel sensor curved camera technology, is a serious part of this invention, as it adds many multiple redundancies for identification of humans and objects. Additionally, the laser communication between server nodes is an important part of the management of the cluster system that is used in this system.

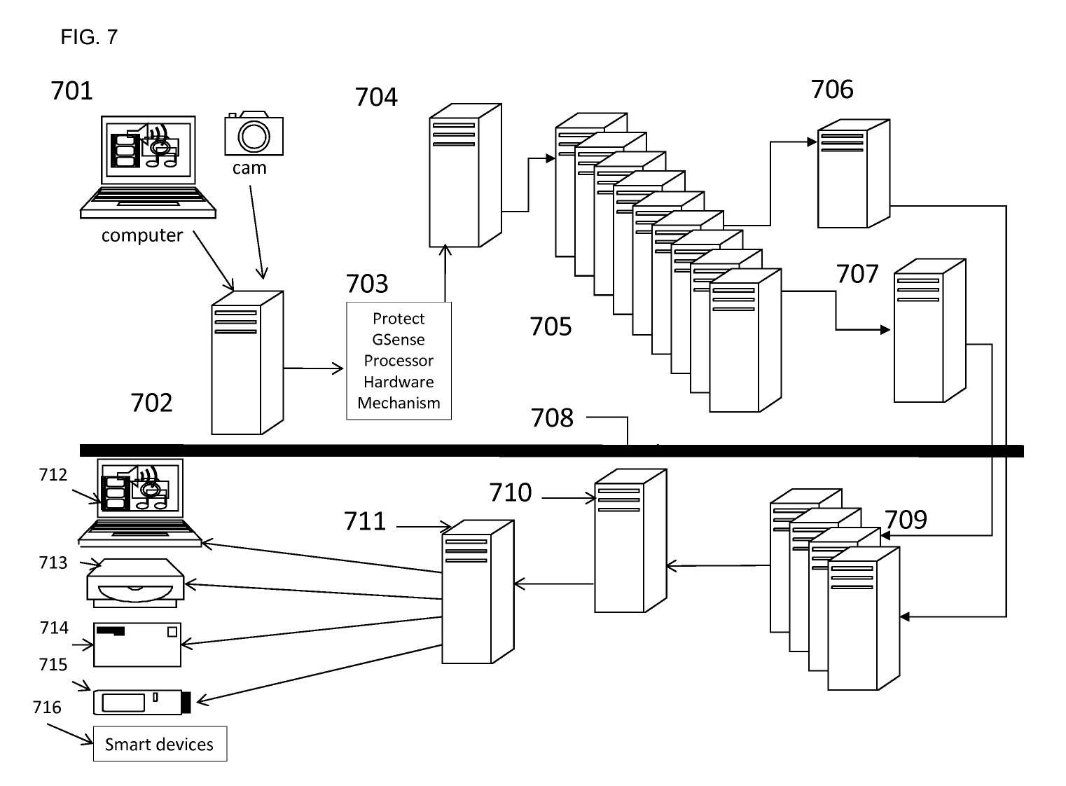

Referring to FIG. 7, a computer or cam 701 accessed a manger server 702 which contains a processor for storing information on a time stamp backup media server 704 which connection to a cluster of storage servers 705. The time stamp backup media server 704 stores the CODEFA and the cluster storage servers 705 store the human key. Digital fingerprint storage servers 706 and Digital segmented storage servers 707 communicate with the cluster storage servers 705 and provide access across a firewall 708 to streaming media servers 709. A server provides human key Video Audio Identification 710 to a manager unit 711 provided with the human key.

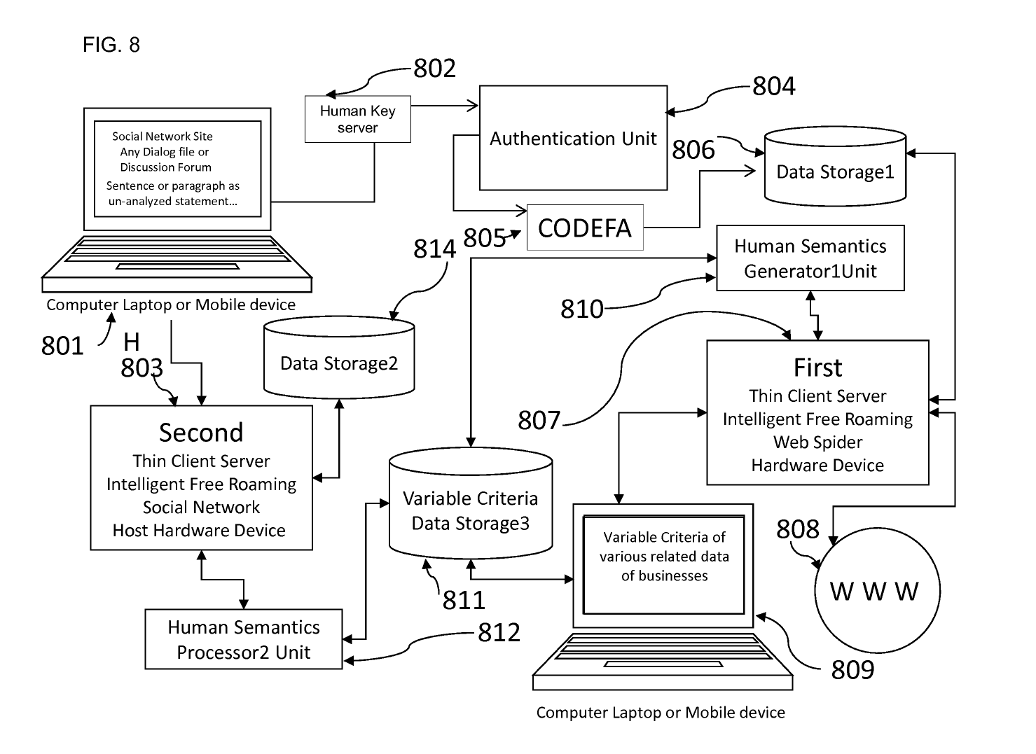

Now referring to FIG. 8, a laptop or mobile device 801 communicates with a human key server 802 and a second thin client server 803. An authentication unit 804 generates a CODEFA 805 and stores it in a first database 806 for transmission to a first thin client server 807. The first thin client server 806 sends and receives information between a human semantics generator unit 810 the world wide web 808 and a second computer or mobile device 809. Variable criteria data storage 811 provides information to the human semantics generator unit 810, second computer or mobile device 809, and a second human semantics processor 812 for transmission to a second thin client server 803 and second data storage 813

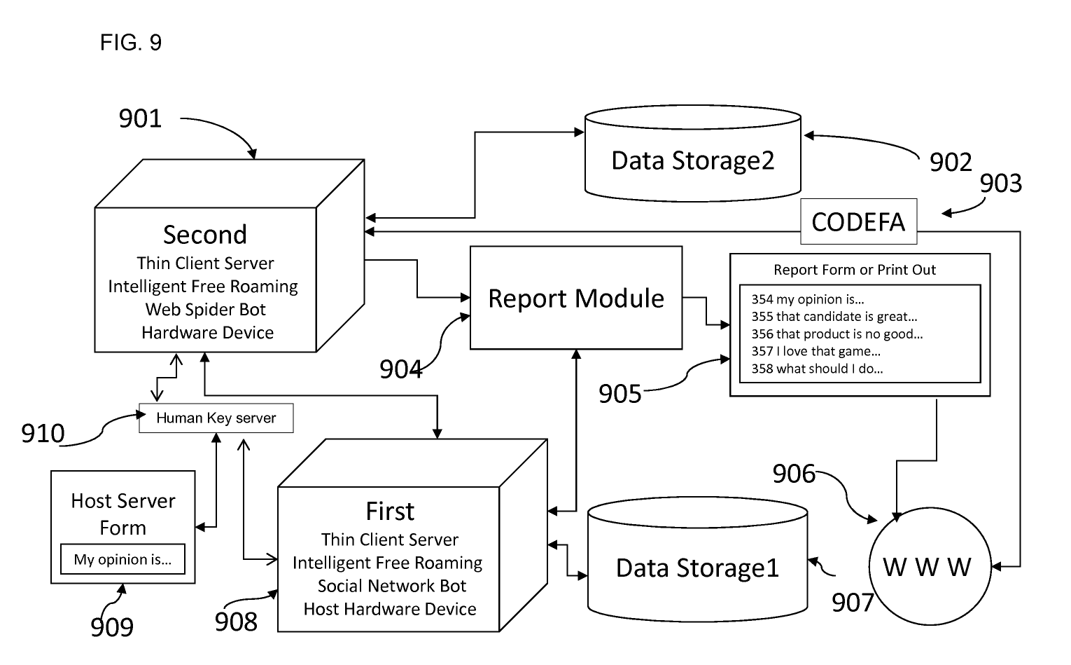

Referring to FIG. 9, the second thin client server 901 transmits information between a second data storage 902, a report module 904, a first thin client server 908, and a human key server 910. CODEFA 903 is transmitted two the second client server 901 and the world wide web 907. The report module 904 generates reports for transmission or print out 905 via the world wide web 907. A first thin client server 908 transmits information to and from a first data storage 906, the report module 904, the second thin client server 901, and to a host server 909 via the human key server 910 for verification.

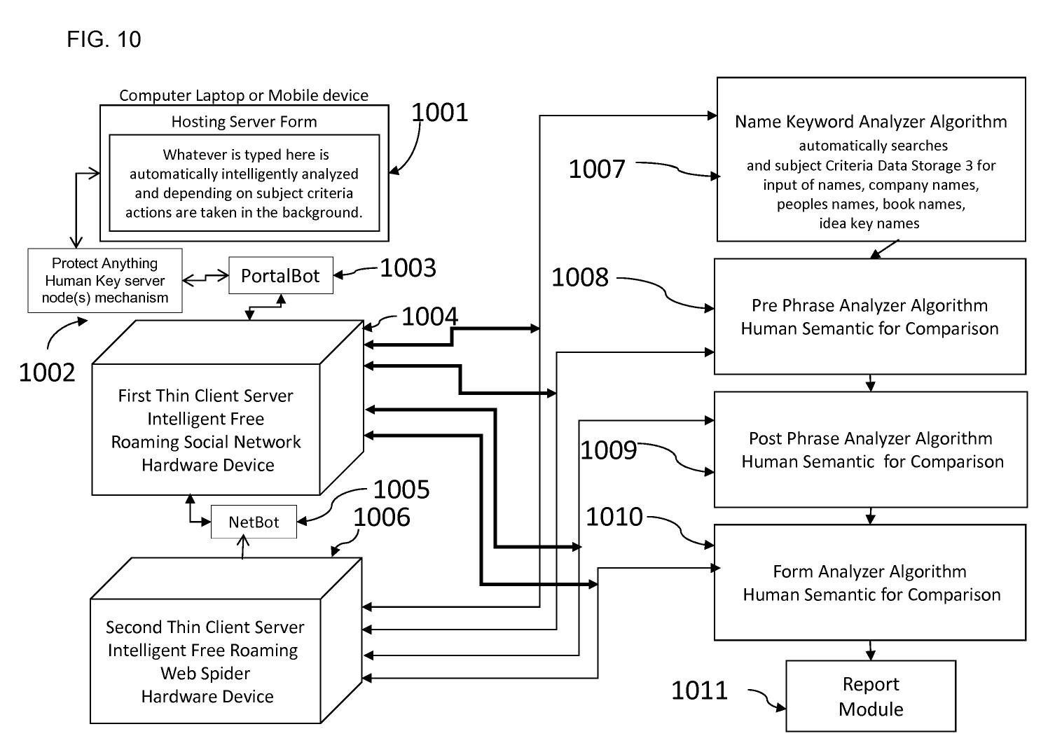

FIG. 10 shows a hosting server form 1001 transmitting information verified by the human key server 1002 via a portalbot 1003 to a first thin client server 1004 and a second thin client server 1006 via a netbot 1005. The thin client servers 1004 and 1006 share information between: a Name Keyword Analyzer Algorithm that automatically searches and subject Criteria Data Storage for input of names, company names, people's names, book names, and idea key names; a Pre Phrase Analyzer Algorithm for Human Semantic comparison between clients 1008; a Post Phrase Analyzer Algorithm for Human Semantic comparison between clients 1009; and a Form Analyzer Algorithm for Human Semantic comparison between clients 1010 which then transmits the output to the report module 1011.

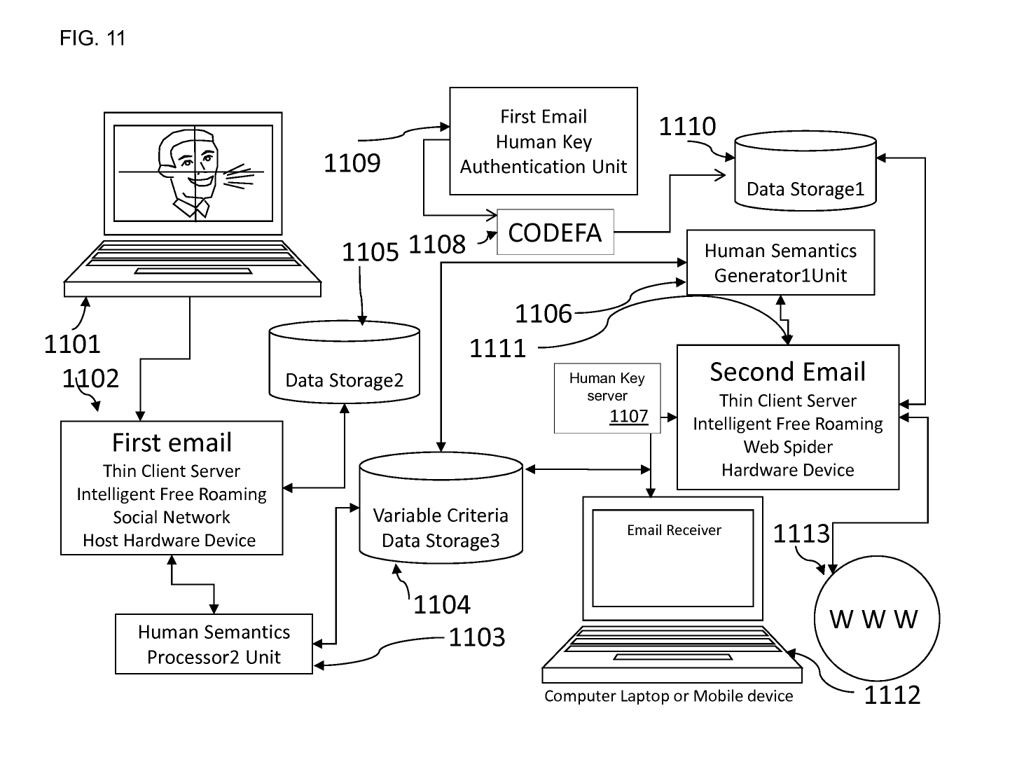

In FIG. 11, a computer laptop or mobile device 1101 connects to a first email thin client server 1102 and data storage 1105, and a second human semantics processor 1103 and variable data storage 1104 for submitting input. A first email human key authentication unit 1109 generates a CODEFA 1108 for storage 1110 and transmission to a first human semantics generator unit 1106 and a second email thin client server 1111 which confirms identification using the human key server 1107 and delivers email to an email retriever's computer or mobile device 1112 or via the world wide web 1113.

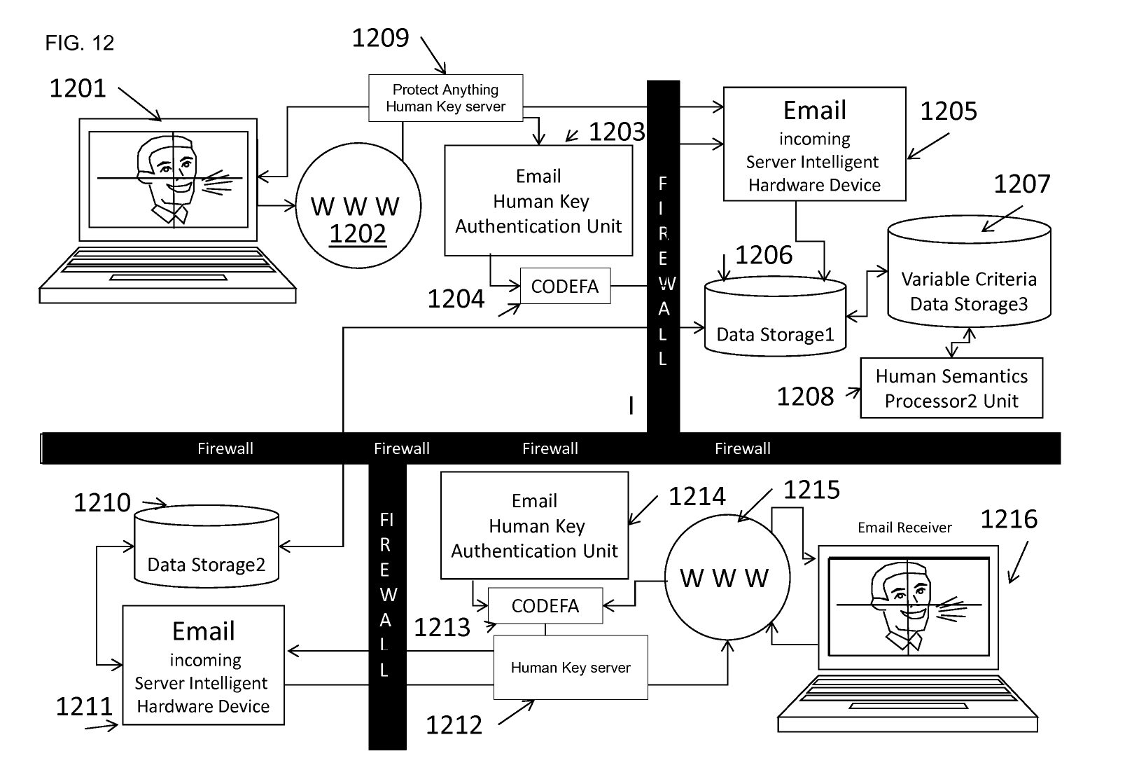

In FIG. 12, and email sender 1201 submits an email via the WWW 1202 to a human key server 1209 which then uses an email human key authentication unit 1203 to generate a CODEFA 1204 for deliver, which the email to an intelligent server device 1205 which stores the email in first data storage 1206, variable criteria storage 1207, and human semantics processor 1208. The email is passed across a firewall from the first data storage 1206 to a second data storage 1210, where a second intelligent email server 1211 authenticates the email with the human key server 1212, CODEFA 1213, and email human key authentication unit 1214 via the WWW 1215 before deliver to the email receiver's computing device 1215.

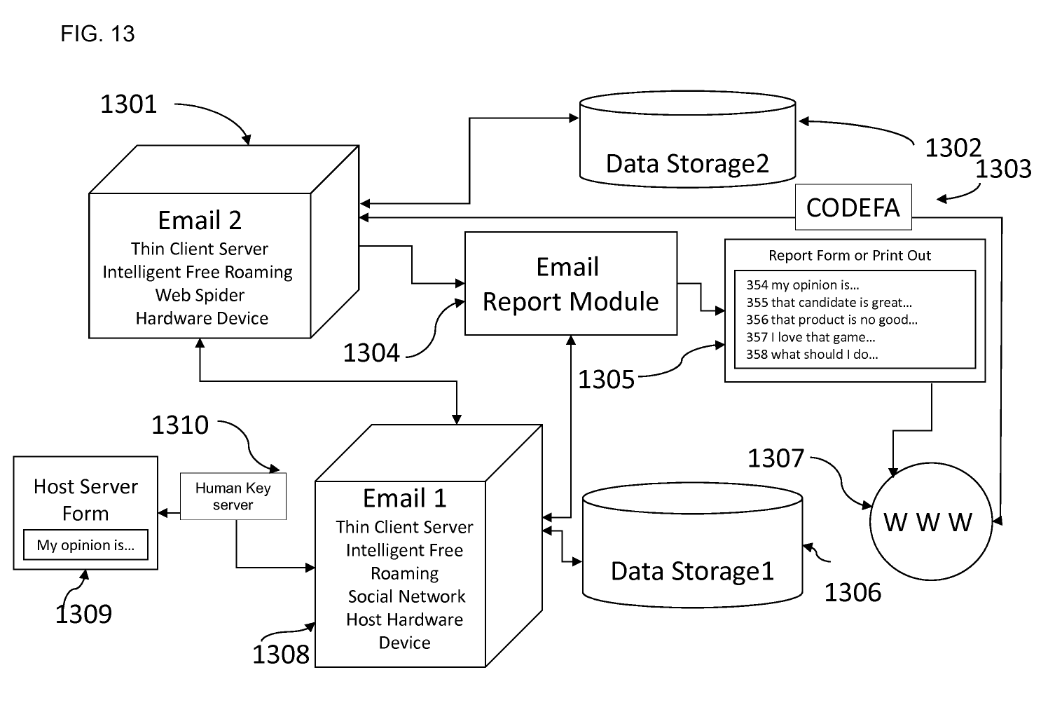

Referring to FIG. 13, the second thin client server 1301 transmits information between a second data storage 1302, a report module 1304, a first thin client server 1308, and a human key server 1310. CODEFA 1303 is transmitted two the second client server 1301 and the world wide web 1307. The report module 1304 generates reports for transmission or print out 1305 via the world wide web 1307. A first thin client server 1308 transmits information to and from a first data storage 1306, the report module 1304, the second thin client server 1301, and to a host server 1309 via the human key server 1310 for verification.

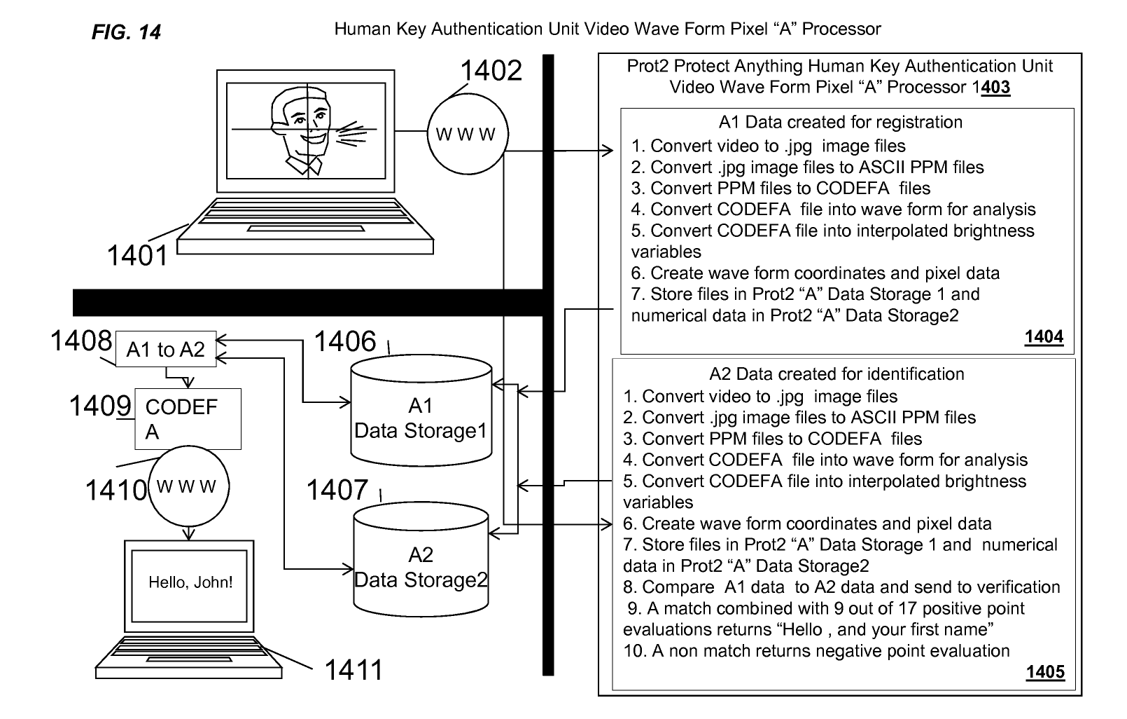

Now referring to FIG. 14, a specimen is a video recorded by a mobile device such as that disclosed in previous figures and streamed to a server for sign-up or sign-in. Working from a computer or mobile device 402 and using an Internet or World Wide Web (WWW) connection 403, a user using a computer or mobile device 1402, accessing an authentication unit 1403.

The authentication unit 1404 creating data for registration 1404 by converting video to .jpg image files; converting .jpg image files to ASCII PPM files; converting PPM files to CODEFA files; converting CODEFA files into wave form for analysis; converting CODEFA files into interpolated brightness variables; creating wave form coordinates and pixel data; and storing files in a first data storage 1406 and numerical data in a second data storage location 1407.

The authentication unit1 403 also creating identification data 1405 by: converting video to .jpg image files; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 1406 and numerical data in a second data storage 1407 and comparing the first data to the second data in step 1408, using a Computer Object De-Encryption Encryption File Algorithm (CODEFA) 1409 and sending to verification; a match combined with 9 out of 17 positive point evaluations returns 1409, via an Internet or WWW connection 1410, “Hello, and your first name” on a display screen of a computer1 411, while a non match returns a negative point evaluation.

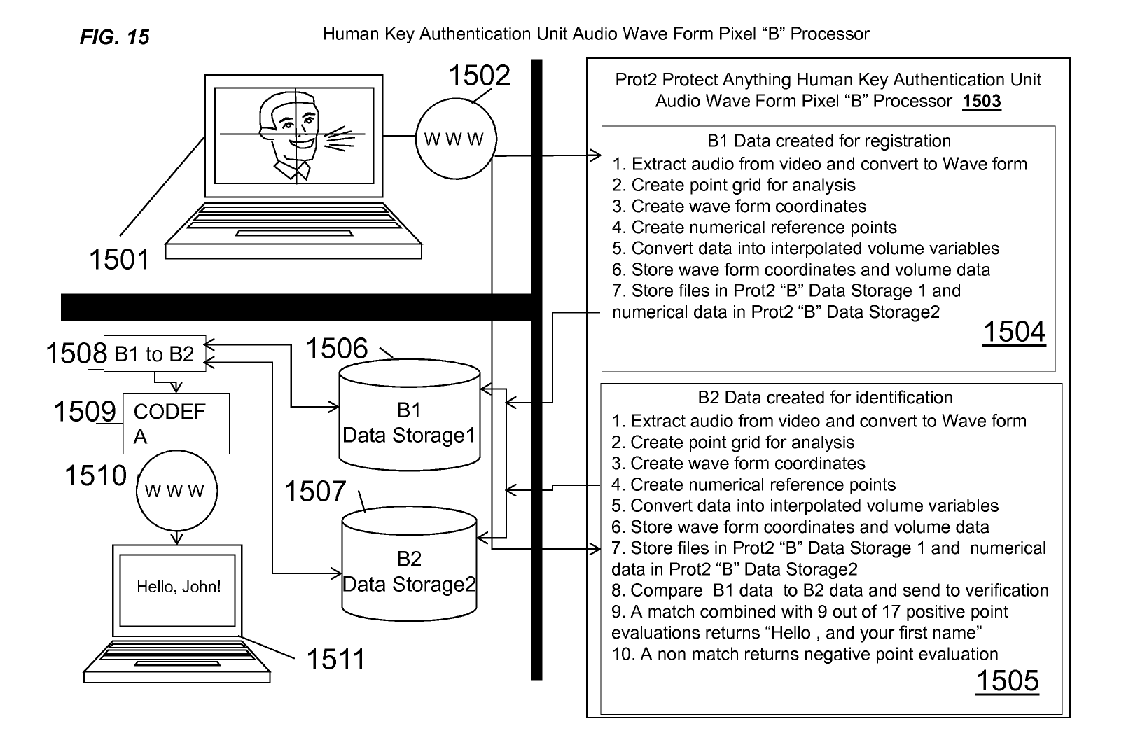

Now referring to FIG. 15, working from a computer or mobile device 1501 and using an Internet or world wide web (WWW) connection 1502, a user using a computer or mobile device 501, accessing an authentication unit 1503.

The authentication unit 1503 creating data for registration 1504 by: extracting audio from video and converting to Wave form; creating a point grid for analysis; creating a form coordinates; creating numerical reference points; converting data into interpolated volume variables; storing wave form coordinates and volume data; and storing files in a first data storage 506 and numerical data in a second data storage 1507.

The authentication unit1 503 also creating data for identification 1505 by: extracting audio from video and converting to Wave form; creating point grid for analysis; creating wave form coordinates creating numerical reference points; converting data into interpolated volume variables; storing form coordinates and volume data; storing files in a first data storage 1506 and numerical data in a second data storage 1507; comparing data stored in the databases in step 1508 and sending to verification by CODEFA 1509; matching combined with 9 out of 17 positive point evaluations returns via an Internet or WWW connection 1510, “Hello, and your first name” on a display screen of a computer 1511, while a non match returns a negative point evaluation.

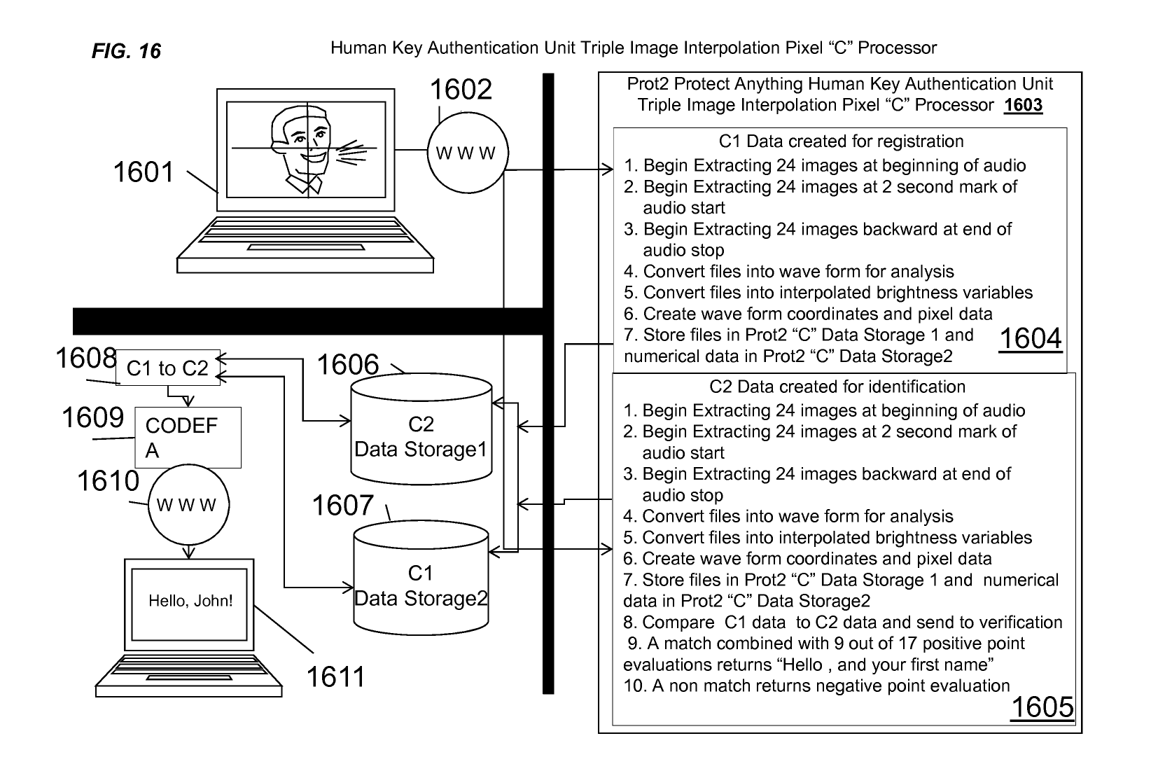

Now referring to FIG. 16, working from a computer or mobile device 1601 and using an Internet or World Wide Web (WWW) connection 1602, a user using a computer or mobile device 1601, accessing an authentication unit 1603.

The authentication unit 1603 creating data for registration 1604 by: extracting 24 images at beginning of audio; extracting 24 images at 2 second mark of audio start; extracting 24 images backward at end of audio stop; converting files into wave form for analysis; converting files into interpolated brightness variables; creating wave form coordinates and pixel data; and storing files in a first data storage 1606 and numerical data in a second data storage 1607.

The authentication unit 1603 also creating data for identification 1605 by: extracting 24 images at beginning of audio; extracting 24 images at 2 second mark of audio start; extracting 24 images backward at end of audio stop; converging into wave form for analysis; converting files into interpolated brightness variables; creating wave form coordinates and pixel data; storing file in a first data storage 1606 and numerical data in a second data storage 1607; comparing data stored in the databases in step 1608 and sending to verification by CODEFA 1609; matching combined with 9 out of 17 positive point evaluations returns via an Internet or WWW connection 610, “Hello, and your first name” on a display screen of a computer 1611, while a non match returns a negative point evaluation.

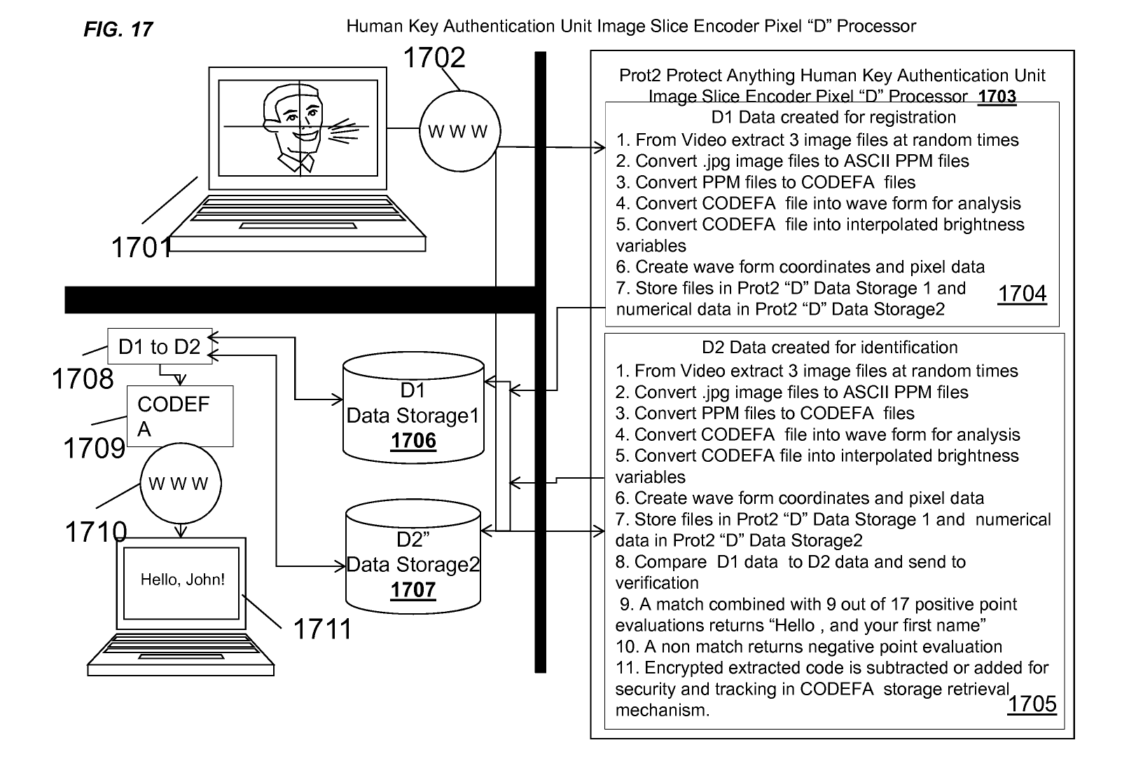

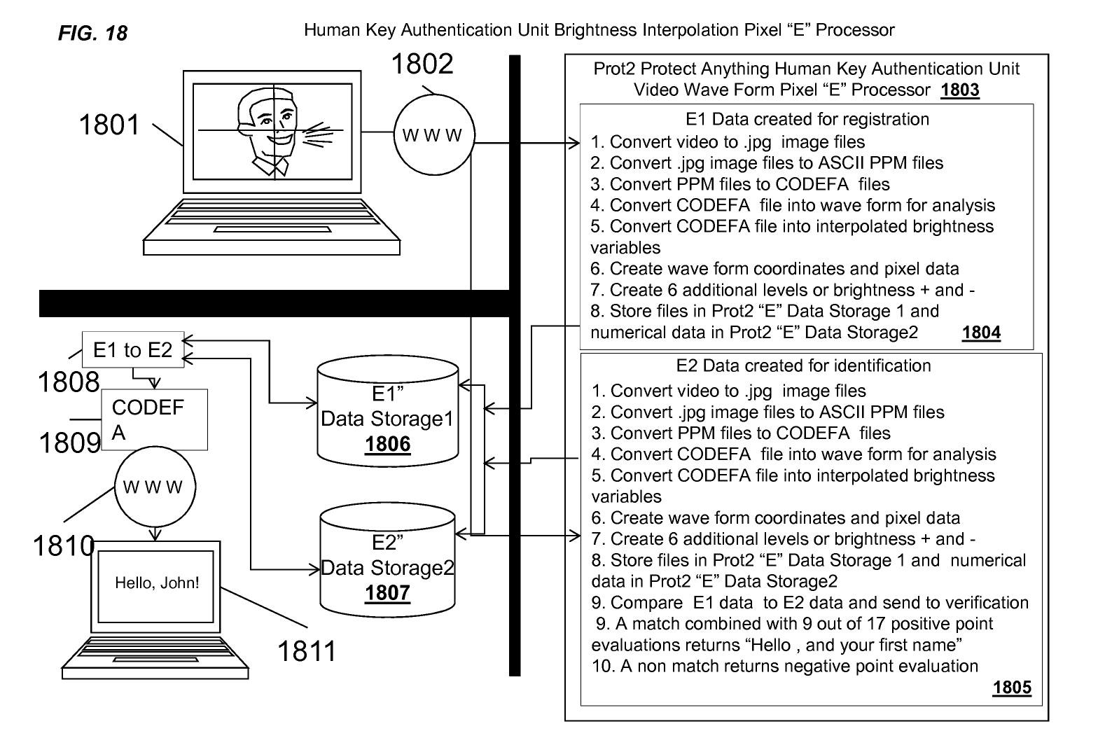

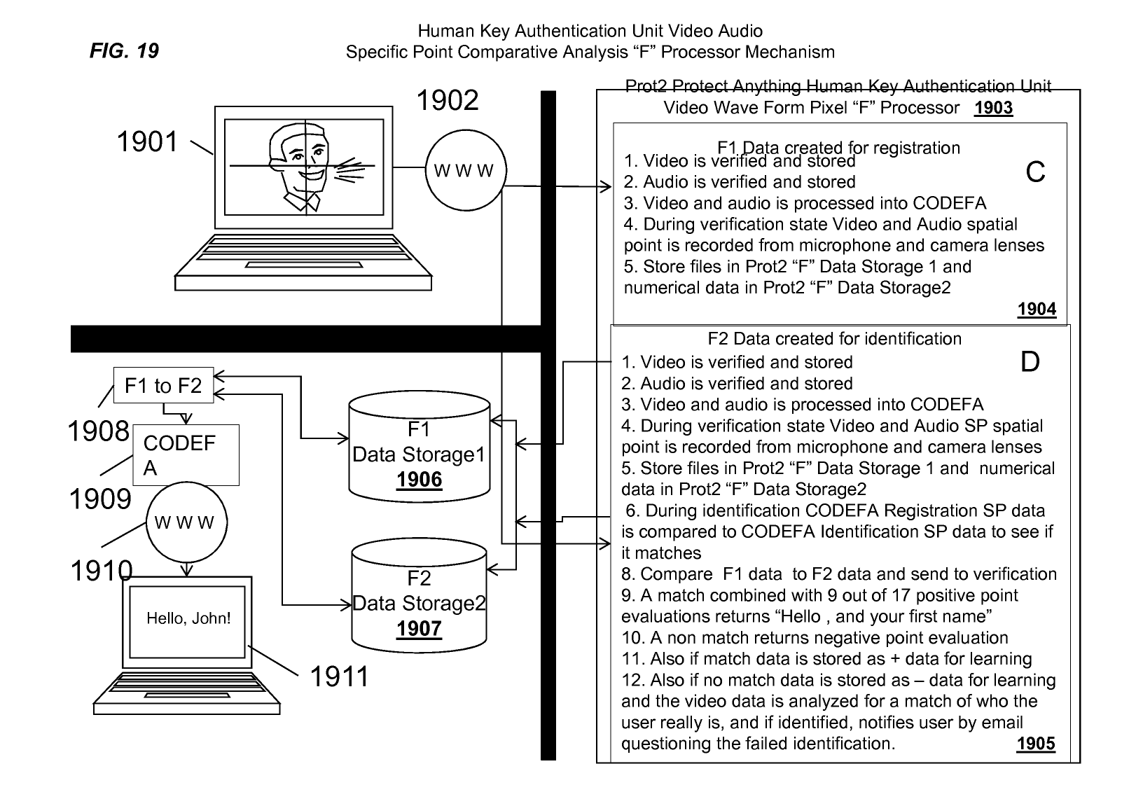

Now referring to FIG. 17, working from a computer or mobile device 1701 and using an Internet or world wide web (WWW) connection 1702, a user using a computer or mobile device 1701, accessing an authentication unit 1703.

The authentication unit 1703 creating data for registration 1704 by: extracting form the video 3 image files at random times; converting .jpg image files to ASCII PPM files; converting PPM files to CODEFA files; converting CODEFA files into wave form for analysis; converting CODEFA files into interpolated brightness variables; creating wave form coordinates and pixel data; and storing files in a first data storage 1706 and numerical data in a second data storage 1706.

The authentication unit 1703 also creating data for identification 1705 by: extracting from video 3 image files at random times; converting .jpg image files to ASCII PPM files; converting PPM files to CODEFA files; converting CODEFA file into wave form for analysis; converting CODEFA files into interpolated brightness variables; creating wave form coordinates and pixel data; storing files in a first data storage 1706 and numerical data in a second data storage 1707; comparing data stored in the databases and send to verification in step 1708; and sending to verification by CODEFA 7109; matching combined with 9 out of 17 positive point evaluations returns via an Internet or WWW connection 1710, “Hello, and your first name” on a display screen of a computer 1711, while a non match returns a negative point evaluation.

Now referring to FIG. 8, working from a computer or mobile device 801 and using an Internet or world wide web (WWW) connection 1802, a user using a computer or mobile device 801, accessing an authentication unit 1803.

The authentication unit 1803 creating data for registration 1804 by: converting video to .jpg image files; converting .jpg image files to ASCII PPM files; converting PPM files to CODEFA files; converting CODEFA file into wave form for analysis; converting CODEFA files into interpolated brightness variables; creating wave form coordinates and pixel data; creating 6 additional levels or brightness + and −; storing files in a first data storage 1806 and numerical data in a second data storage 1807.

The authentication unit 1803 also creating data for identification 1805 by: converting video to .jpg image files; converting.jpg image files to ASCII PPM files; converting PPM files to CODEFA files; converting CODEFA file into wave form for analysis; converting CODEFA files into interpolated brightness variables; creating wave form coordinates and pixel data; creating 6 additional levels or brightness + and −; and storing files in a first data storage 1806 and numerical data in a second data storage 1807; comparing data stored in the databases in step 8108 and sending to verification by CODEFA 1809; matching combined with 9 out of 17 positive point evaluations returns via an Internet or WWW connection 1810, “Hello, and your first name” on a display screen of a computer 1811, while a non match returns a negative point evaluation.

Now referring to FIG. 9, working from a computer or mobile device 1901 and using an Internet or world wide web (WWW) connection 1902, a user using a computer or mobile device 1901, accessing an authentication unit 1903.

The authentication unit 1903 creating data for registration 1904 by: Video is verified and stored; Audio is verified and stored; Video and audio is processed into CODEFA; During verification state Video and Audio spatial point is recorded from microphone and camera lenses; and storing files in a first data storage 1906 and numerical data in a second data storage 1907.

The authentication unit 1903 also creating data for identification 1905 by: Video is verified and stored; Audio is verified and stored; Video and audio is processed into CODEFA; During verification state Video and Audio SP spatial point is recorded from microphone and camera lenses; storing files in a first data storage 1906 and numerical data in a second data storage 1907; During identification CODEFA Registration SP data is compared to CODEFA Identification SP data to see if it matches 1909; comparing data and send to verification in step 1908; a match combined with 9 out of 17 positive point returns via an Internet or WWW connection 1910, “Hello, and your first name” on a display screen of a computer 1911. A non match returns negative point evaluation; if match data is stored as + data for learning; if no match data is stored as—data for learning and the video data is analyzed for a match of who the user really is, and if identified, notifies user by email questioning the failed identification.

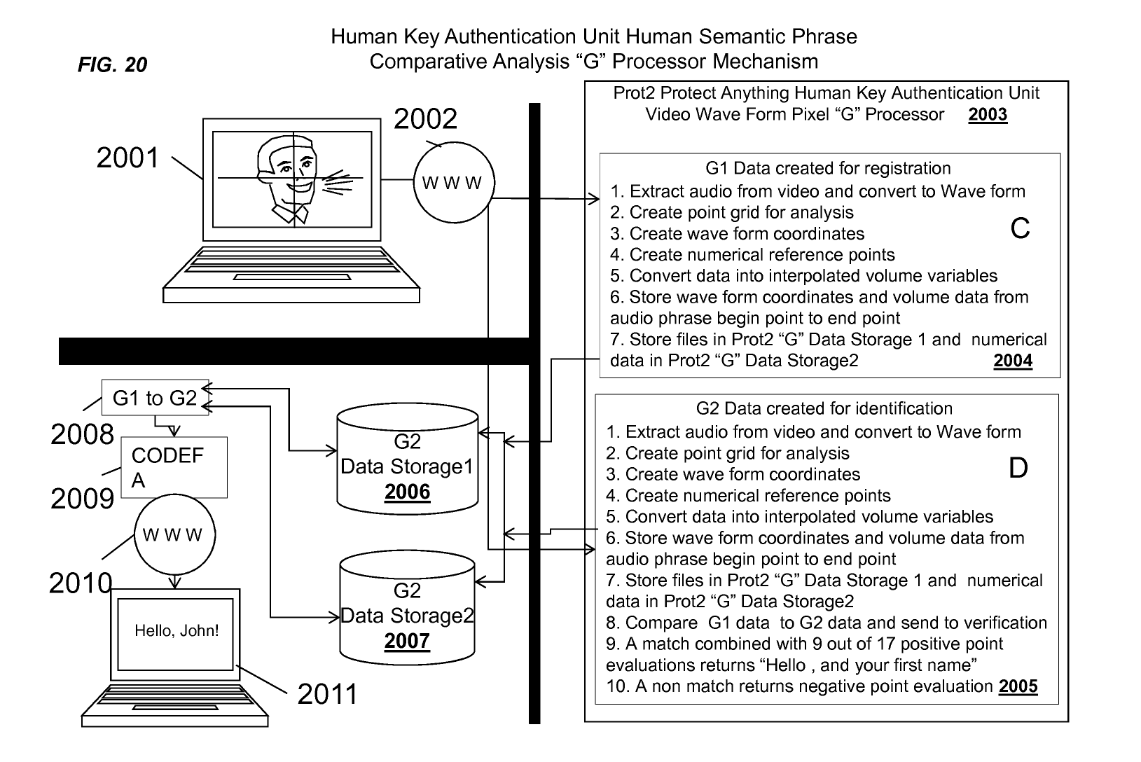

Now referring to FIG. 20, working from a computer or mobile device 1001 and using an Internet or world wide web (WWW) connection 2002, a user using a computer or mobile device 2001, accessing an authentication unit 2003.

The authentication unit 2003 creating data for registration 2004 by: Extracting audio from video and converting to Wave form; creating point grid for analysis; creating wave form coordinates; creating numerical reference points; converting data into interpolated volume variables; storing wave form coordinates and volume data from audio phrase begin point to end point; and storing files in a first data storage 2006 and numerical data in a second data storage 2007.

The authentication unit 2003 also creating data for identification 2005 by: Extracting audio from video and converting to Wave form; creating point grid for analysis; creating wave form coordinates; creating numerical reference points; converting data into interpolated volume variables; storing wave form coordinates and volume data from audio phrase begin point to end point; storing files in a first data storage 2006 and numerical data in a second data storage 2007; comparing data and send to verification in step 2008; and sending to verification by CODEFA 2009; matching combined with 9 out of 17 positive point evaluations returns via an Internet or WWW connection 2010, “Hello, and your first name” on a display screen of a computer 2011, while a non match returns a negative point evaluation.

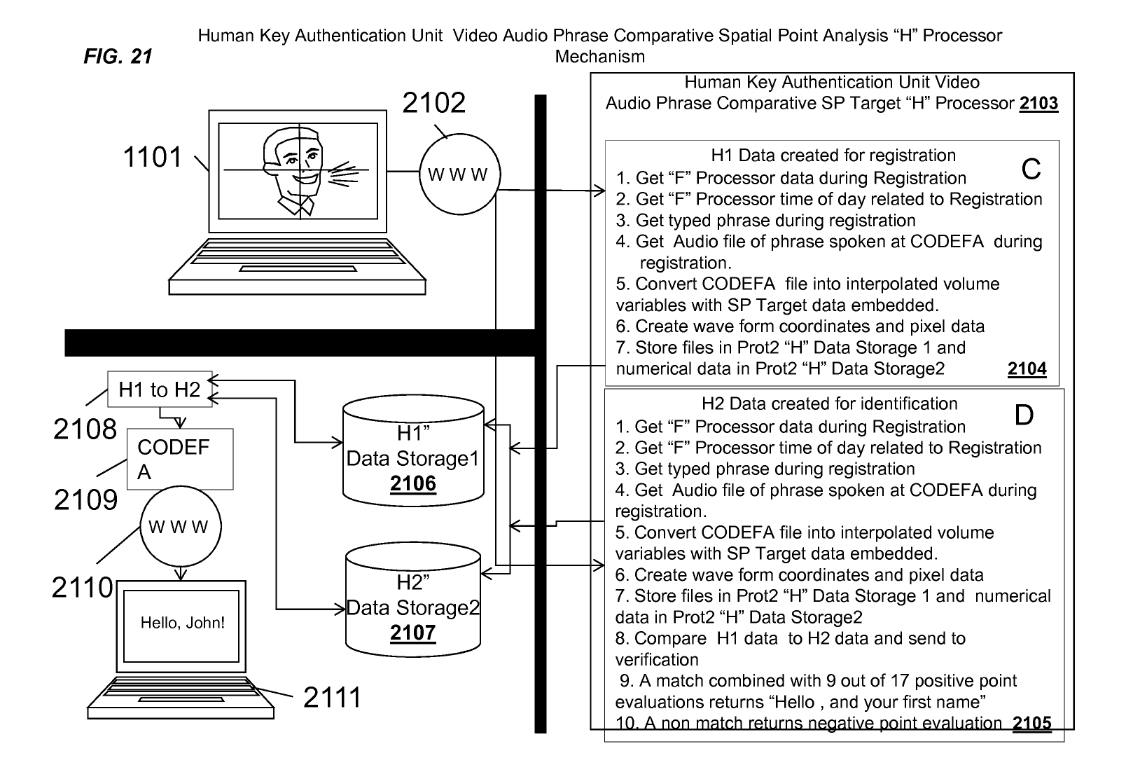

Now referring to FIG. 21, working from a computer or mobile device 2101 and using an Internet or world wide web (WWW) connection 2102, a user using a computer or mobile device 2101, accessing an authentication unit 2103.

The authentication unit 1103 creating data for registration 2104 by: Receiving Processor data during Registration; Receiving “Processor time of day related to Registration; Receiving typed phrase during registration; Receiving Audio file of phrase spoken at CODEFA during registration; converting CODEFA file into interpolated volume variables with SP Target data embedded; creating wave form coordinates and pixel data; and storing files in a first data storage 2106 and numerical data in a second data storage 2107.

The authentication unit 2103 also creating data for identification 2105 by: Receiving Processor data during Registration; Receiving Processor time of day related to Registration; Receiving typed phrase during registration; Receiving Audio file of phrase spoken at CODEFA during registration; converting CODEFA files into interpolated volume variables with SP Target data embedded; creating wave form coordinates and pixel data; storing files in a first data storage 2106 and numerical data in a second data storage 2107; comparing data and send to verification in step 2108; and sending to verification by CODEFA 2109; matching combined with 9 out of 17 positive point evaluations returns via an Internet or WWW connection 2110, “Hello, and your first name” on a display screen of a computer 2111, while a non match returns a negative point evaluation.

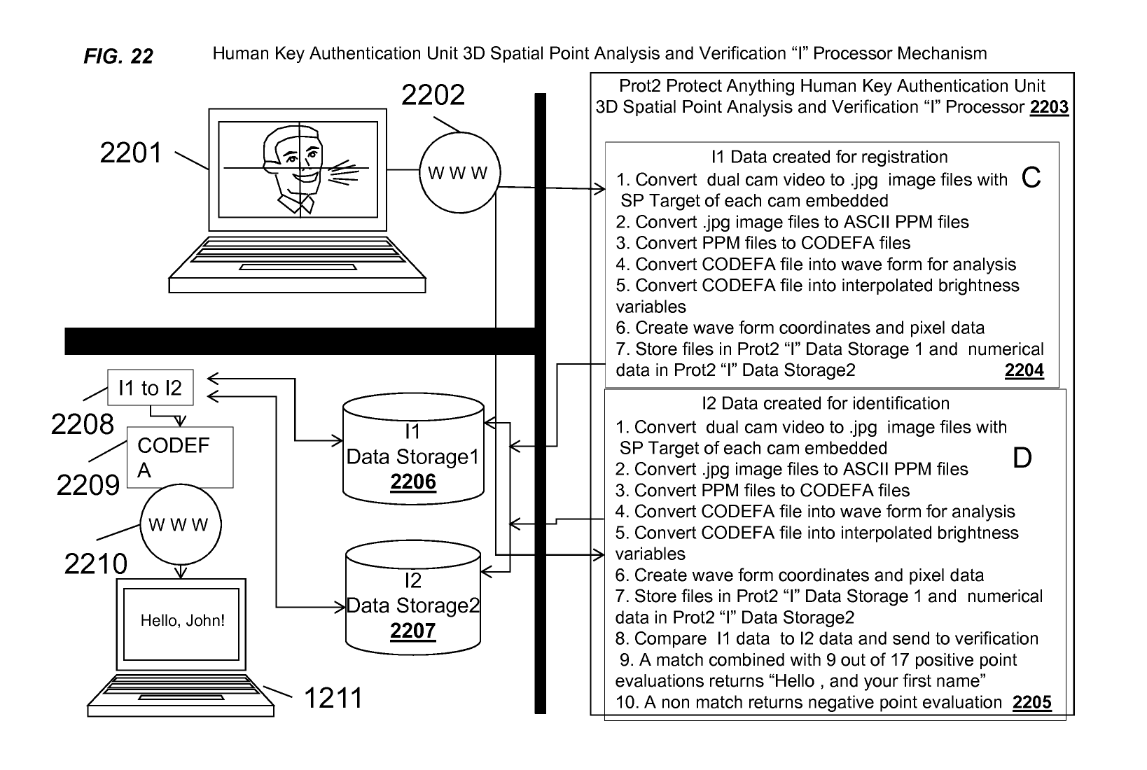

Now referring to FIG. 22, working from a computer or mobile device 2201 and using an Internet or world wide web (WWW) connection 2202, a user using a computer or mobile device 2201, accessing an authentication unit 2203.

The authentication unit 2203 creating data for registration 2204 by: converting dual cam video to .jpg image files with SP Target of each cam embedded; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 2206 and numerical data in a second data storage 2207.

The authentication unit 2203 also creating data for identification 2205 by: converting dual cam video to .jpg image files with SP Target of each cam embedded; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 2206 and numerical data in a second data storage 2207; comparing data and send to verification in step 2208; and sending to verification by CODEFA 2209; matching combined with 9 out of 17 positive point evaluations returns via an Internet or WWW connection 2210, “Hello, and your first name” on a display screen of a computer 2211, while a non match returns a negative point evaluation.

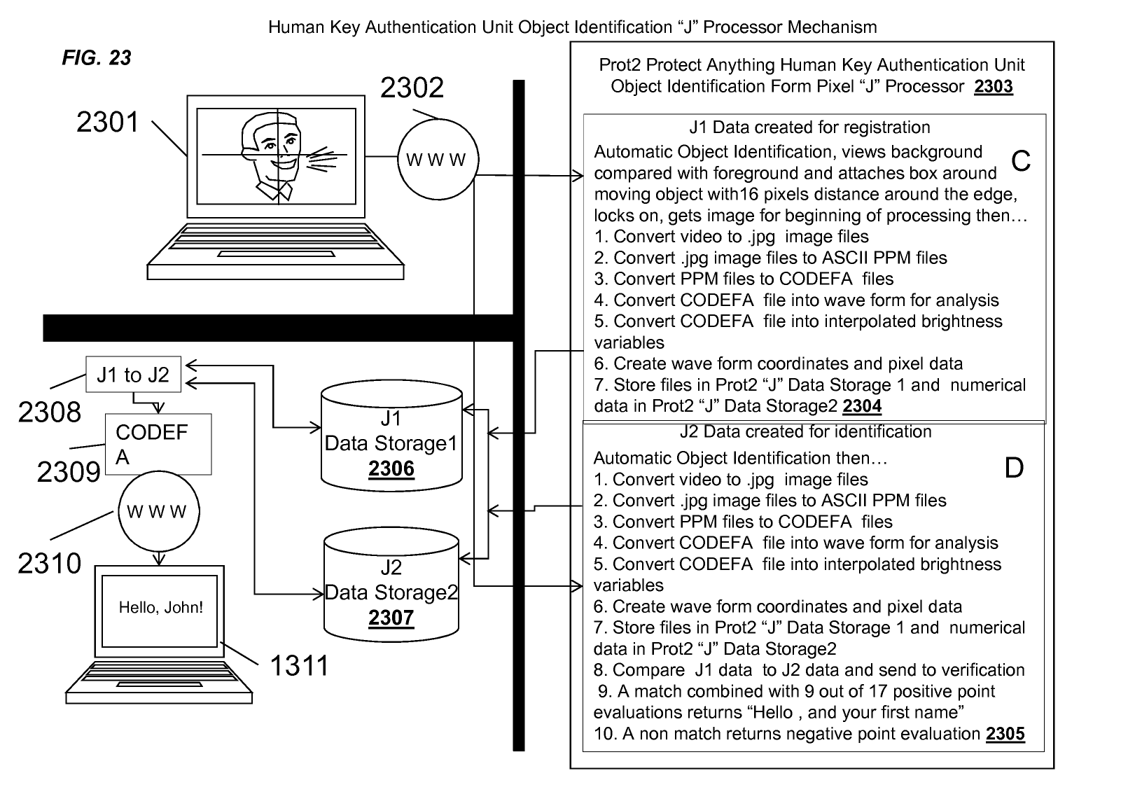

Now referring to FIG. 23, working from a computer or mobile device 2301 and using an Internet or world wide web (WWW) connection 2302, a user using a computer or mobile device 2301, accessing an authentication unit 2303.

The authentication unit 2303 creating data for registration 2304 Automatic Object Identification, views background compared with foreground and attaches box around moving object with 16 pixels distance around the edge, locks on, gets image for beginning of processing then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 2306 and numerical data in a second data storage 2307.

The authentication unit 2303 also creating data for identification 2305 by Automatic Object Identification then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 2306 and numerical data in a second data storage 2307; comparing data and send to verification in step 2308; and sending to verification by CODEFA 2309; matching combined with 9 out of 17 positive point evaluations returns via an Internet or WWW connection 2310, “Hello, and your first name” on a display screen of a computer 2311, while a non match returns a negative point evaluation.

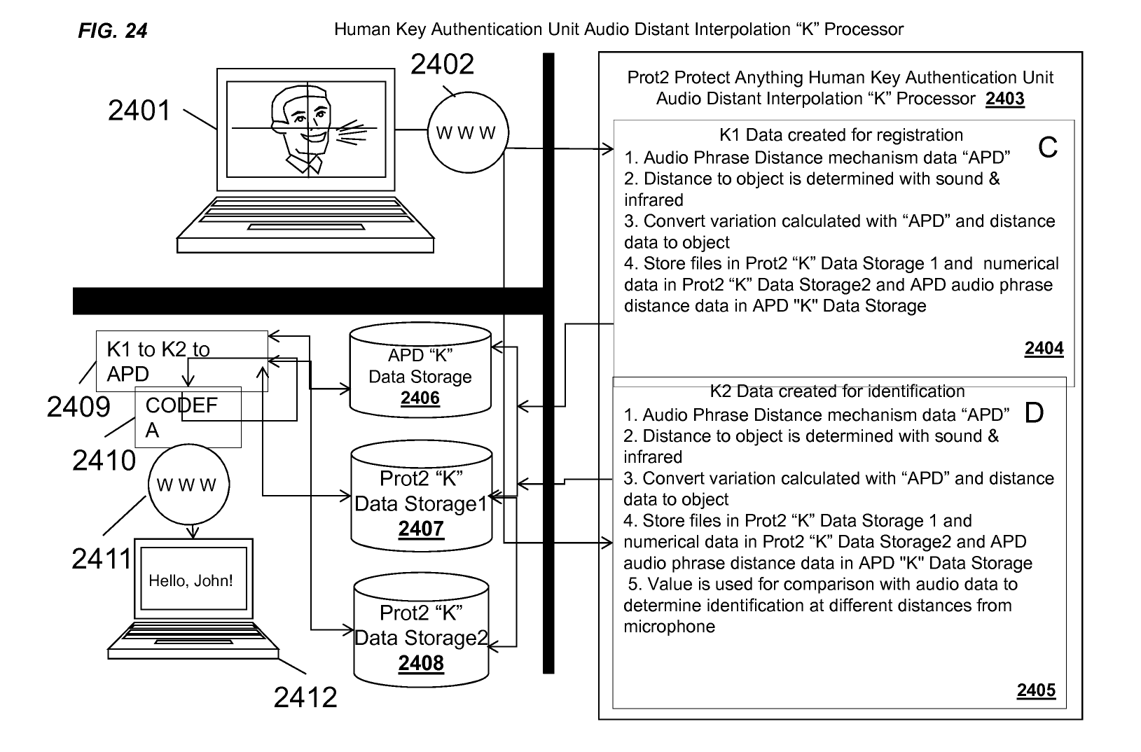

Now referring to FIG. 24, working from a computer or mobile device 2401 and using an Internet or world wide web (WWW) connection 2402, a user using a computer or mobile device 2401, accessing an authentication unit 2403.

The authentication unit 2403 creating data for registration 2404 by: using an Audio Phrase Distance device comprised of on the phone or device, that sending data back to the main server for evaluation and decision to determine Distance to object using sound and infrared data; converting variation calculated with “APD” and distance data to object data; storing files in a first data storage 2406, numerical data in a second data storage 2407, and audio phrase distance data in a third data storage 2408.

The authentication unit 2403 also creating data for identification 2405 by: using an Audio Phrase Distanced (ADP) device to determine Distance to object using sound and infrared data; converting variation calculated with “APD” and distance data to object data; storing files in a first data storage 2406, numerical data in a second data storage 2407, and audio phrase distance data in a third data storage 2408 and values are used for comparison with audio data to determine identification at different distances from microphone in step 2408. Matching combined with 9 out of 17 positive point evaluations returns via an Internet or WWW connection 2410, “Hello, and your first name” on a display screen of a computer 2411, while a non match returns a negative point evaluation.

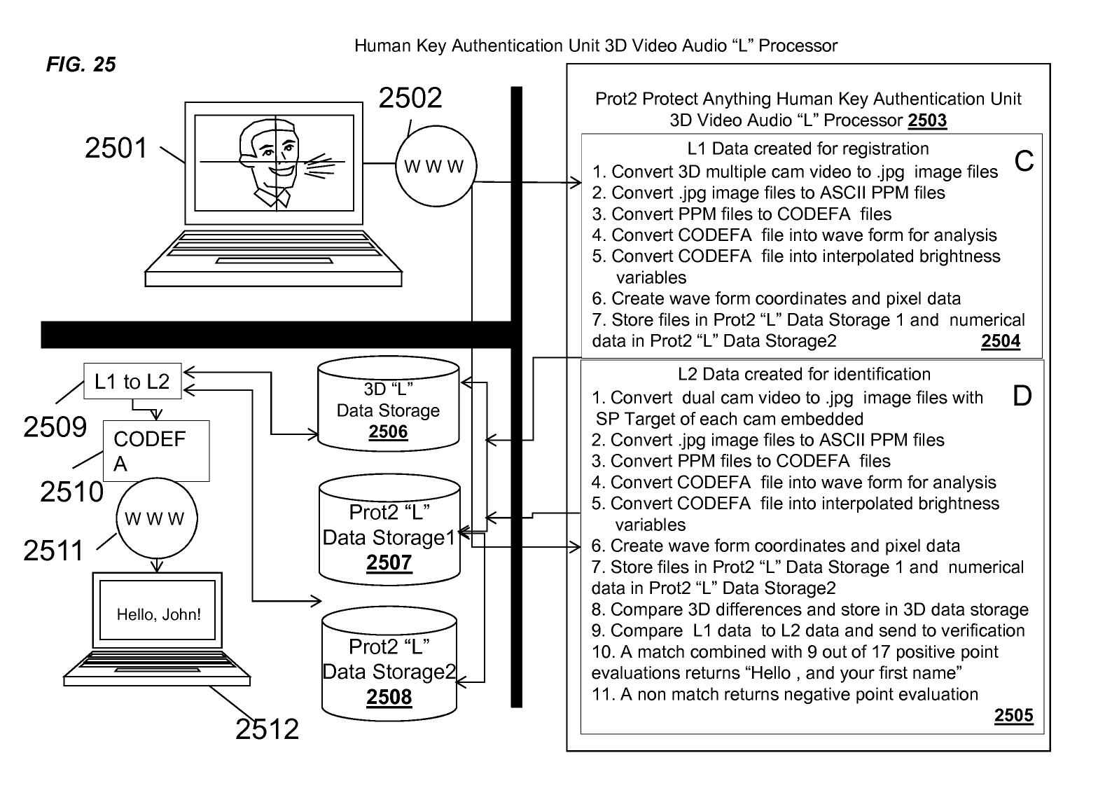

Now referring to FIG. 25, working from a computer or mobile device 2501 and using an Internet or world wide web (WWW) connection 2502, a user using a computer or mobile device 2501, accessing an authentication unit 2503.

The authentication unit 2503 creating data for registration 2504 by: converting 3D multiple cam video to .jpg image files; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 2506 and numerical data in a second data storage 2507.

The authentication unit 2503 also creating data for identification 2505 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2506 and numerical data in a second data storage 2507; comparing 3D differences and store in 3D data storage 2508; comparing data in a first data storage 2506 and numerical data in a second data storage 2507 in step 2509 and send to verification in step 2510; A match combined with 9 out of 17 positive point evaluations returns via an Internet or WWW connection 2510, “Hello, and your first name” on a display screen of a computer 2511, while a non match returns a negative point evaluation.

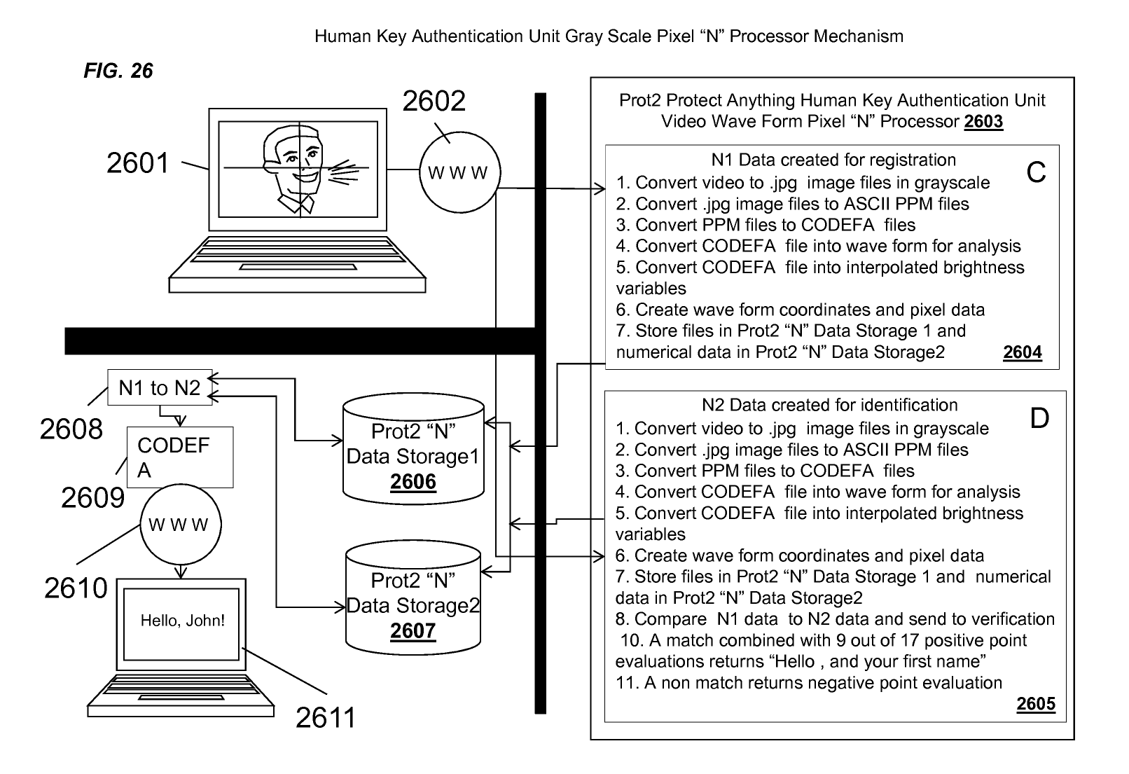

Now referring to FIG. 26, working from a computer or mobile device 2601 and using an Internet or world wide web (WWW) connection 2602, a user using a computer or mobile device 2601, accessing an authentication unit 2603.

The authentication unit 2603 creating data for registration 2604 by: converting video to .jpg image files in grayscale; converting .jpg image files to ASCII PPM files; converting PPM files to CODEFA files; converting CODEFA files into wave form for analysis; converting CODEFA files into interpolated brightness variables; creating wave form coordinates and pixel data; and storing files in a first data storage 2606 and numerical data in a second data storage 2607.

The authentication unit 2603 also creating data for identification 2605 by: converting video to .jpg image files in grayscale; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2606 and numerical data in a second data storage 2607; comparing data stored in the databases 2608 and send to verification in step 2609. A match combined with 9 out of 17 positive point evaluations returns via an Internet or WWW connection 2610, “Hello, and your first name” on a display screen of a computer 2611, while a non match returns a negative point evaluation.

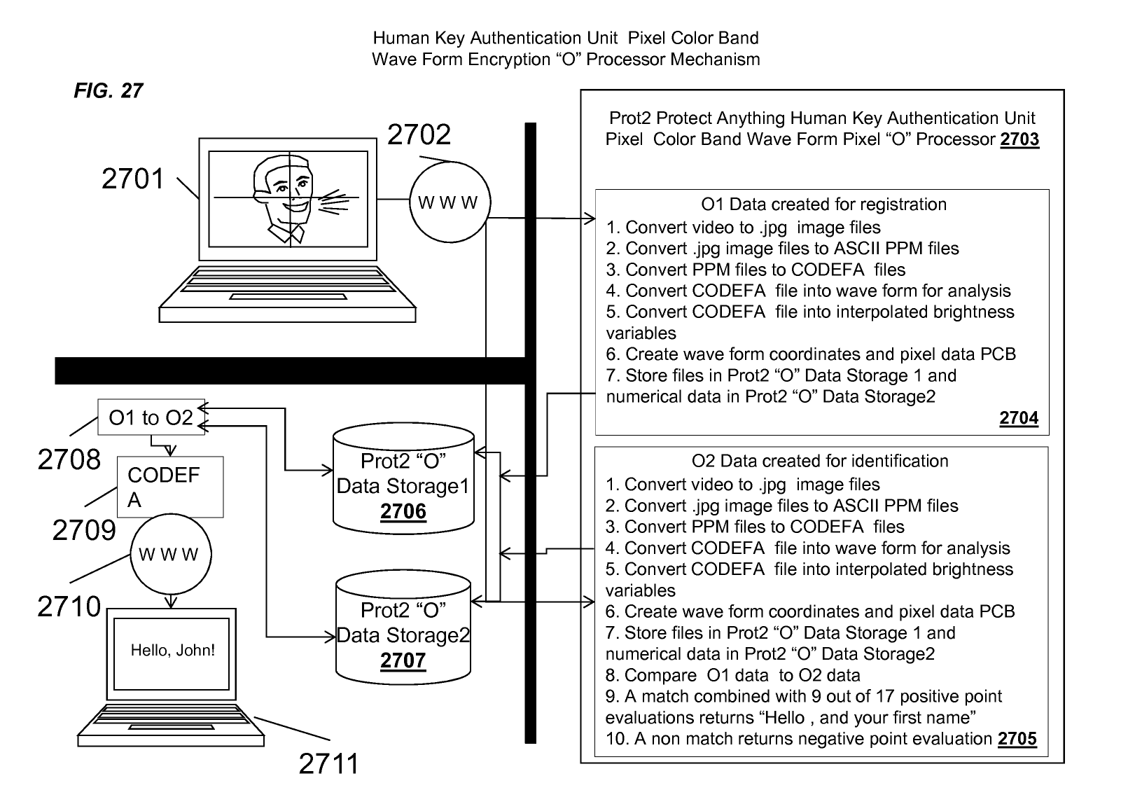

Now referring to FIG. 27, working from a computer or mobile device 2701 and using an Internet or world wide web (WWW) connection 2702, a user using a computer or mobile device 2701, accessing an authentication unit 2703.

The authentication unit 2703 creating data for registration 2704 by: converting video to .jpg image files; converting .jpg image files to ASCII PPM files; converting PPM files to CODEFA files; converting CODEFA files into wave form for analysis; converting CODEFA files into interpolated brightness variables; creating wave form coordinates and pixel data PCB; and storing files in a first data storage 2706 and numerical data in a second data storage 2707.

The authentication unit 2703 also creating data for identification 2705 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data PCB; storing files in a first data storage 2706 and numerical data in a second data storage 2707; comparing data stored in the databases in step 2708 using CODEFA 1709. A match combined with 9 out of 17 positive point evaluations returns via an Internet or WWW connection 2710, “Hello, and your first name” on a display screen of a computer 2711, while a non match returns a negative point evaluation.

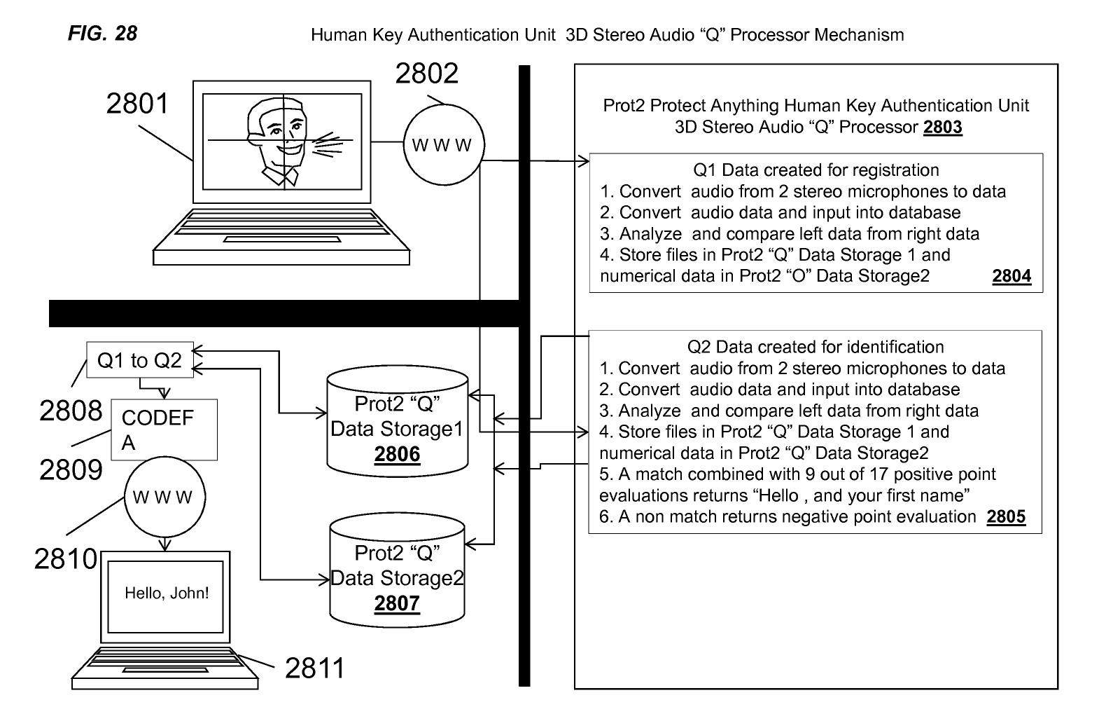

Now referring to FIG. 28, working from a computer or mobile device 2801 and using an Internet or world wide web (WWW) connection 2802, a user using a computer or mobile device 2801, accessing an authentication unit 2803.

The authentication unit 2803 creating data for registration 2804 by: converting audio from 2 stereo microphones to data; converting audio data and input into database; Analyze and compare left data from right data; and storing files in a first data storage 2806 and numerical data in a second data storage 2807.

The authentication unit 2803 creating data for identification 2805 by: converting audio from two stereo microphones to data; converting audio data and input into databases; analyzing and comparing left date from right data; storing files in a first data storage 2806 and numerical data in a second data storage 2807. comparing data stored in the databases in step 2808 using CODEFA 2809. A match combined with 9 out of 17 positive point evaluations returns via an Internet or WWW connection 2810, “Hello, and your first name” on a display screen of a computer 1811, while a non match returns a negative point evaluation.

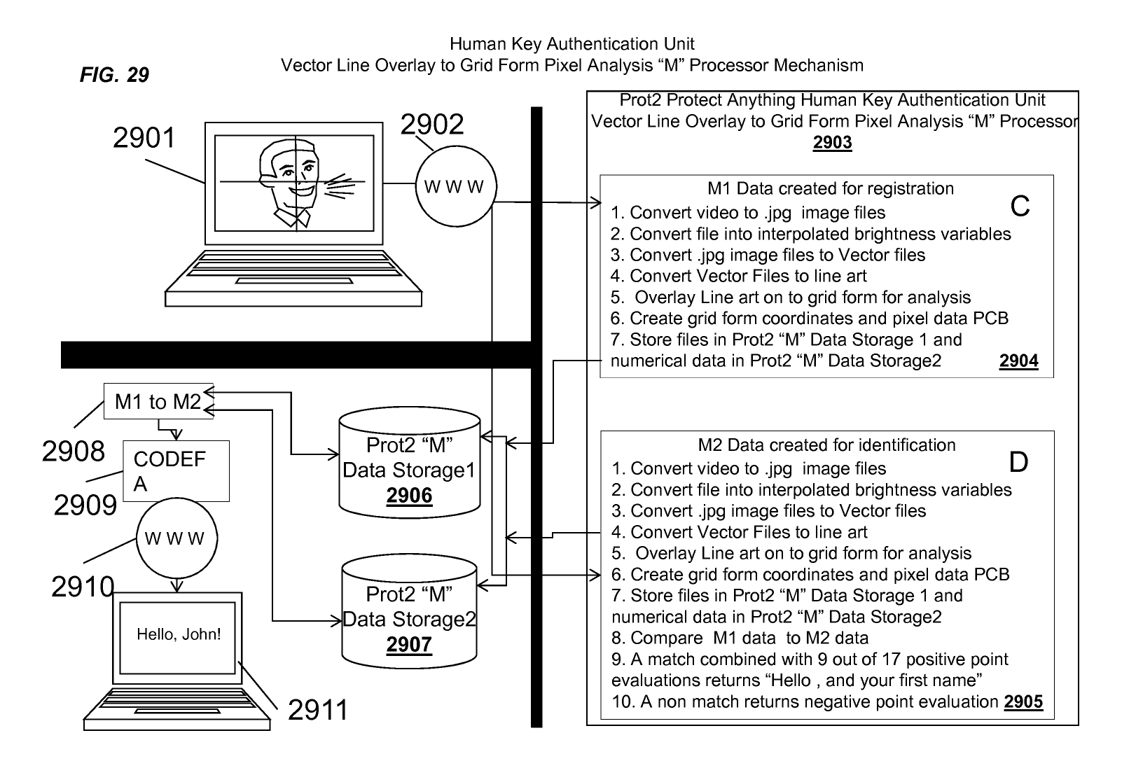

Now referring to FIG. 29, a working from a computer or mobile device 2901 and using an Internet or world wide web (WWW) connection 2902, a user using a computer or mobile device 2901, accessing an authentication unit 2903.

The authentication unit 2903 creating data for registration 2904 by: converting video to .jpg image files; converting file into interpolated brightness variables; converting .jpg image files to Vector files; converting Vector Files to line art; overlaying Line art on to grid form for analysis; creating grid form coordinates and pixel data PCB; and storing files in a first data storage 2906 and numerical data in a second data storage 2907.

The authentication unit 2903 creating data for identification 2905 by: converting video to .jpg image files; converting file into interpolated brightness variables; converting .jpg image files to Vector files; converting Vector Files to line art; overlaying Line art on to grid form for analysis; creating grid form coordinates and pixel data PCB; storing files in a first data storage 2906 and numerical data in a second data storage 2907; comparing data in step 2908 using CODEFA 2909. A match combined with 9 out of 17 positive point evaluations returns via an Internet or WWW connection 2910, “Hello, and your first name” on a display screen of a computer 2911, while a non match returns a negative point evaluation.

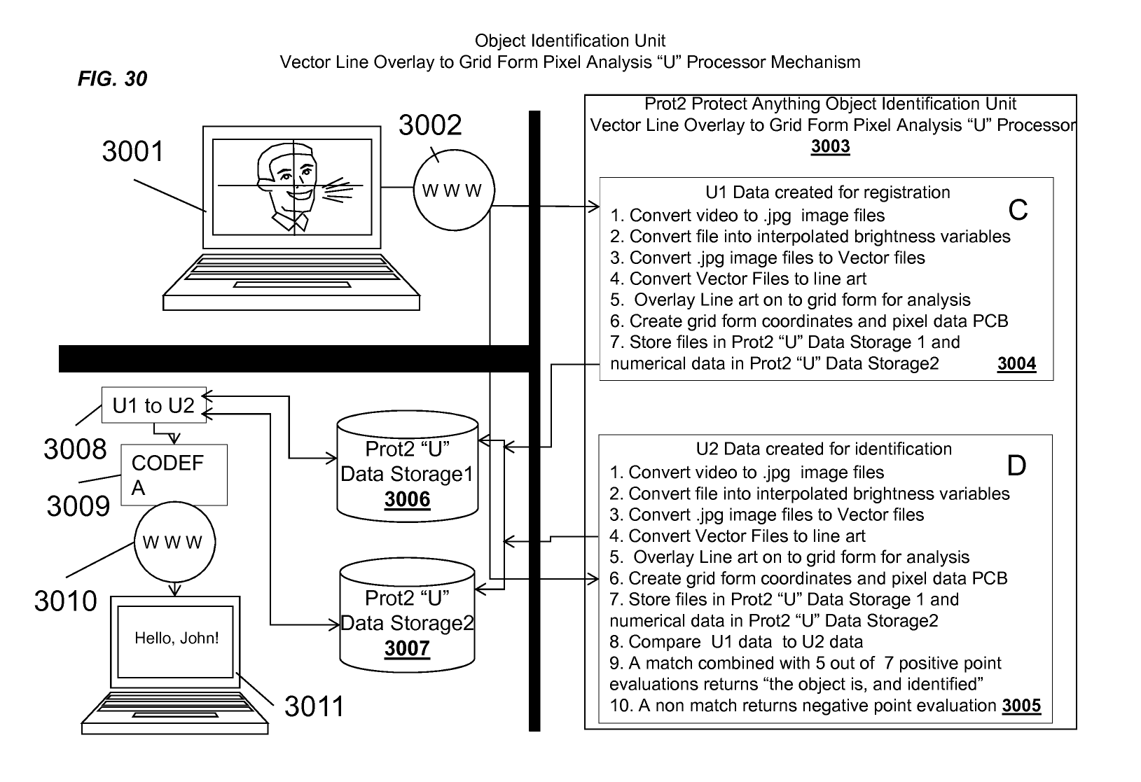

Now referring to FIG. 30, working from a computer or mobile device 3001 and using an Internet or world wide web (WWW) connection 3002, a user using a computer or mobile device 3001, accessing an authentication unit 3003.

The authentication unit 3003 creating data for registration 3004 by: converting video to .jpg image files; converting file into interpolated brightness variables; converting .jpg image files to Vector files; converting Vector Files to line art; overlaying Line art on to grid form for analysis; creating grid form coordinates and pixel data PCB; and storing files in a first data storage 3006 and numerical data in a second data storage 3007.

The authentication unit 3003 creating data for identification 3005 by: converting video to .jpg image files; converting file into interpolated brightness variables; converting .jpg image files to Vector files; converting Vector Files to line art; overlaying Line art on to grid form for analysis; creating grid form coordinates and pixel data PCB; storing files in a first data storage 3006 and numerical data in a second data storage 3007; comparing data stored in the databases in step 3008 using CODEFA 3009. A match combined with 9 out of 17 positive point evaluations returns via an Internet or WWW connection 3010, “Hello, and your first name” on a display screen of a computer 3011, while a non match returns a negative point evaluation.

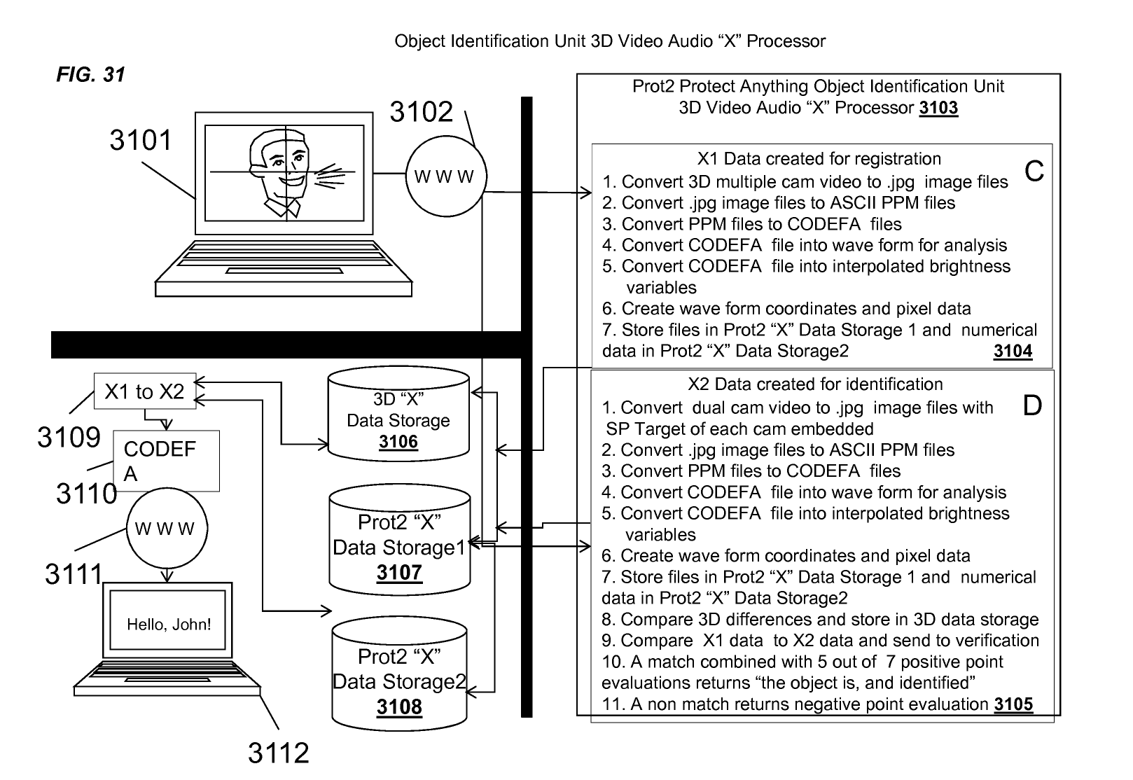

Now referring to FIG. 31, working from a computer or mobile device 3101 and using an Internet or world wide web (WWW) connection 3102, a user using a computer or mobile device 3101, accessing an authentication unit 3103.

The authentication unit 3103 creating data for registration 3104 by: converting 3D multiple cam video to .jpg image files; converting .jpg image files to ASCII PPM files; converting PPM files to CODEFA files; converting CODEFA files into wave form for analysis; converting CODEFA files into interpolated brightness variables; creating wave form coordinates and pixel data; and storing files in a first data storage 3106 and numerical data in a second data storage 3107.

The authentication unit 3103 creating data for identification 3105 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 3106 and numerical data in a second data storage 3107; comparing 3D differences and store in 3D data storage 3108; comparing data and send to verification in step 3109 using CODEFA. A match combined with 9 out of 17 positive point evaluations returns via an Internet or WWW connection 3110, “Hello, and your first name” on a display screen of a computer 3111, while a non match returns a negative point evaluation.

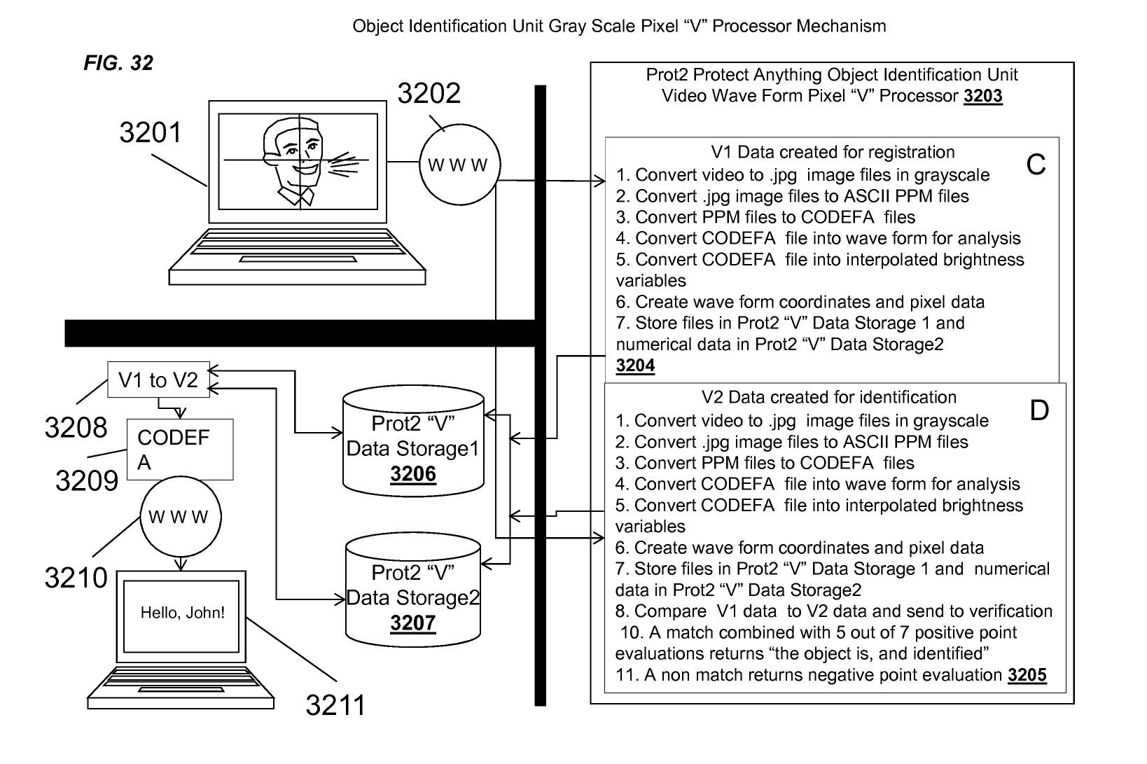

Now referring to FIG. 32, working from a computer or mobile device 3201 and using an Internet or world wide web (WWW) connection 3202, a user using a computer or mobile device 3201, accessing an authentication unit 3203.

The authentication unit 3203 creating data for registration 3204 by: converting video to .jpg image files in grayscale; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 3206 and numerical data in a second data storage 3207.

The authentication unit 3203 creating data for identification 3205 by: converting video to .jpg image files in grayscale; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 3206 and numerical data in a second data storage 3207; comparing V1 data to V2 data in step 3208 and send to verification using CODEFA 3209. A match combined with 9 out of 17 positive point evaluations returns via an Internet or WWW connection 3110, “Hello, and your first name” on a display screen of a computer 3111, while a non match returns a negative point evaluation.

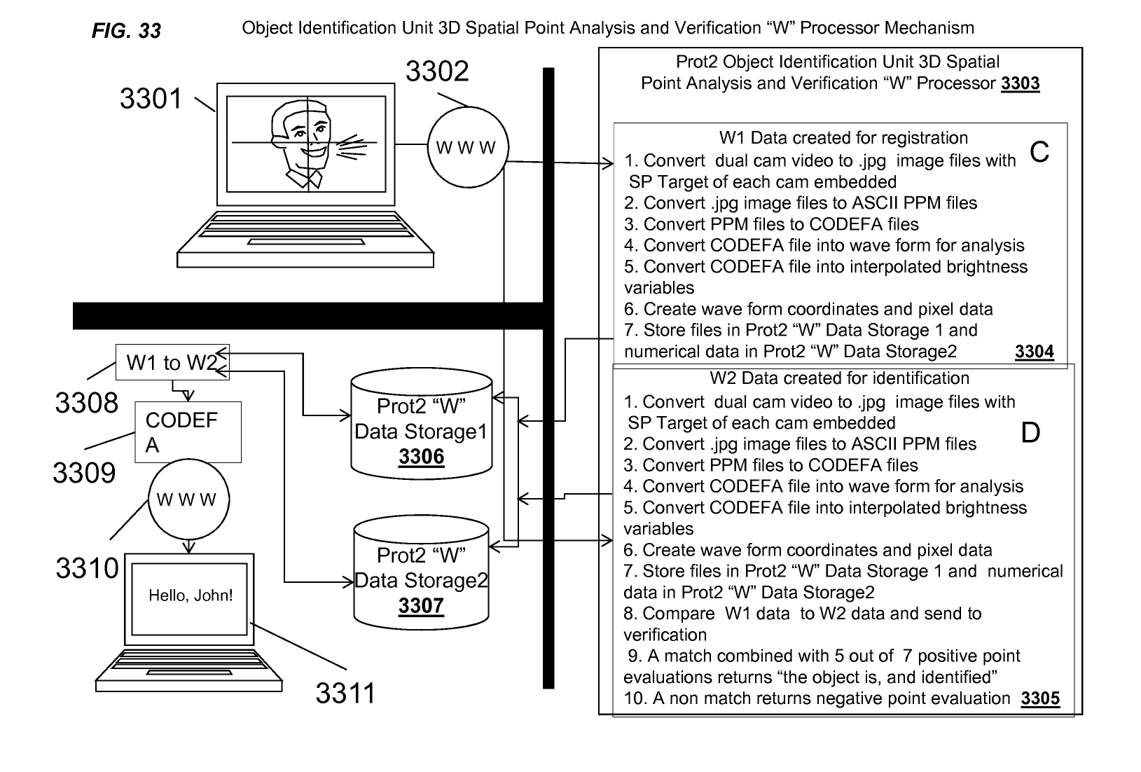

Now referring to FIG. 33, a specimen is a video recorded by a mobile device such as that disclosed in FIGS. 1a-1c and streamed to a server for sign-up or sign-in. Working from a computer or mobile device 3301 and using an Internet or world wide web (WWW) connection 3302, a user using a computer or mobile device 3301, accessing an authentication unit 3303.

The authentication unit 3303 creating data for registration 3304 by: converting dual cam video to .jpg image files with SP Target of each cam embedded; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 3306 and numerical data in a second data storage 3307.

The authentication unit 3303 creating data for identification 3305 by: converting dual cam video to .jpg image files with SP Target of each cam embedded; converting .jpg image files to ASCII PPM files; converting PPM files to CODEFA files; converting CODEFA files into wave form for analysis; converting CODEFA files into interpolated brightness variables; creating wave form coordinates and pixel data; storing files in a first data storage 3306 and numerical data in a second data storage 3307; comparing data in step 3308 and send to verification using CODEFA in step 3309. A match combined with 9 out of 17 positive point evaluations returns via an Internet or WWW connection 3310, “Hello, and your first name” on a display screen of a computer 3311, while a non match returns a negative point evaluation.

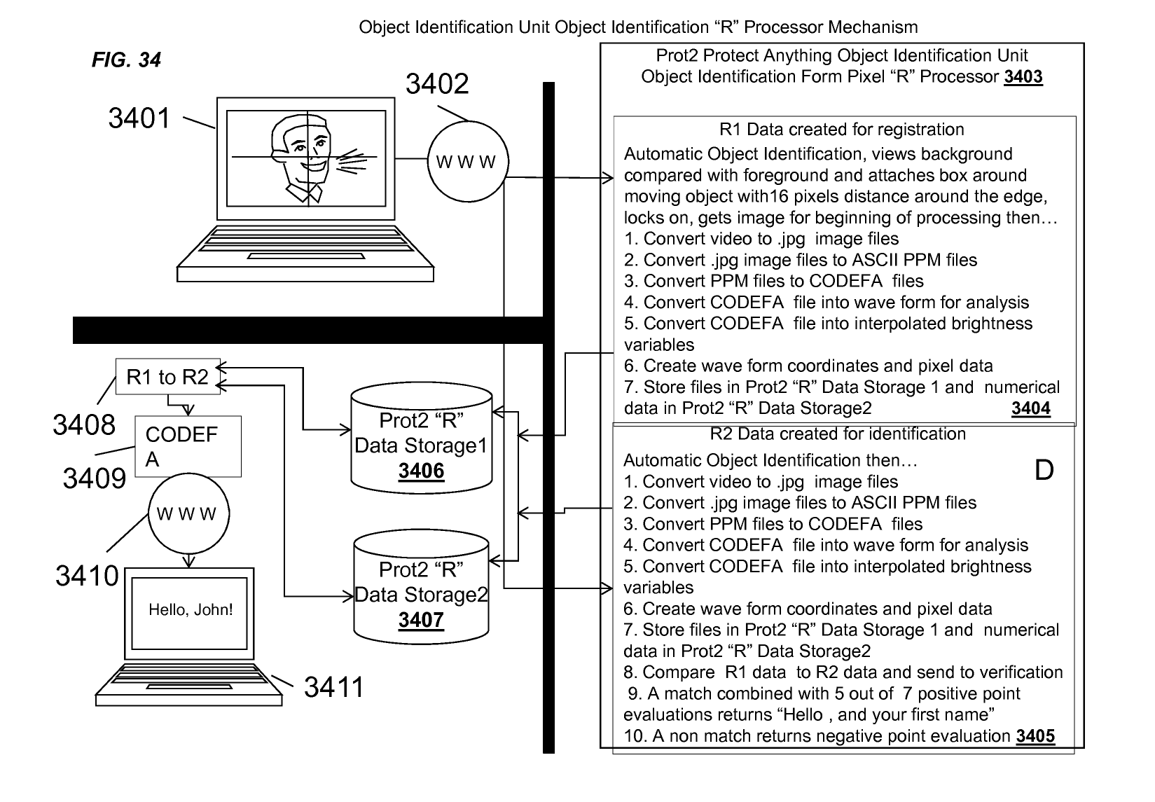

Now referring to FIG. 34, working from a computer or mobile device 3401 and using an Internet or world wide web (WWW) connection 3402, a user using a computer or mobile device 3401, accessing an authentication unit 3403.

The authentication unit 3403 creating data for registration 3404 by Automatic Object Identification, views background compared with foreground and attaches box around moving object with 16 pixels distance around the edge, locks on, gets image for beginning of processing then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 3406 and numerical data in a second data storage 3407.

The authentication unit 3403 creating data for identification 3405 by Automatic Object Identification then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 3406 and numerical data in a second data storage 3407; comparing data stored in the databases in step 3408 and send to verification via CODEFA in step 3409. A match combined with 9 out of 17 positive point evaluations returns via an Internet or WWW connection 3410, “Hello, and your first name” on a display screen of a computer 3411, while a non match returns a negative point evaluation.

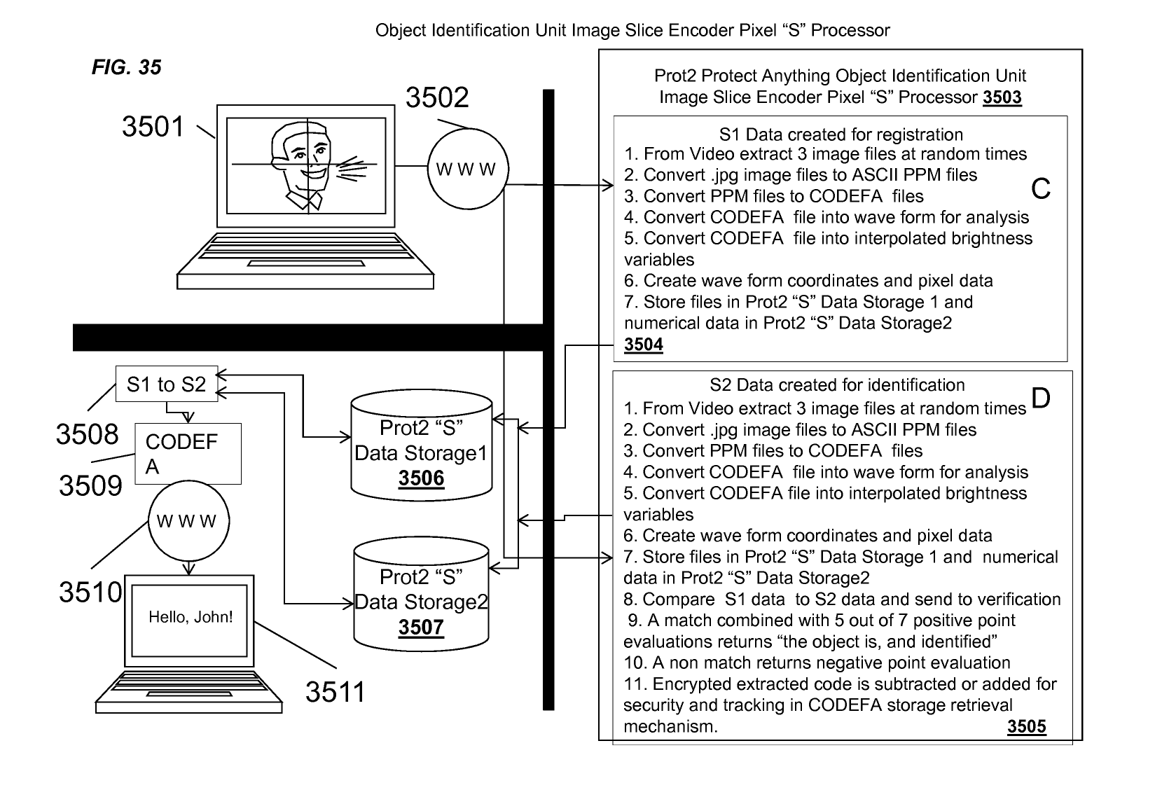

Now referring to FIG. 35, working from a computer or mobile device 3501 and using an Internet or world wide web (WWW) connection 3502, a user using a computer or mobile device 3501, accessing an authentication unit 3503.

The authentication unit 3503 creating data for registration 3504 by: extracting from video 3 image files at random times; converting .jpg image files to ASCII PPM files; converting PPM files to CODEFA files; converting CODEFA files into wave form for analysis; converting CODEFA files into interpolated brightness variables; creating wave form coordinates and pixel data; and storing files in a first data storage 3506 and numerical data in a second data storage 3507.

The authentication unit 3503 creating data for identification 3505 by: extracting from video 3 image files at random times; converting .jpg image files to ASCII PPM files; converting PPM files to CODEFA files; converting CODEFA file into wave form for analysis; converting CODEFA files into interpolated brightness variables; creating wave form coordinates and pixel data; storing files in a first data storage 3506 and numerical data in a second data storage 3507; comparing data stored in the databases in step 3508 and send to verification using CODEFA in step 3509. A match combined with 9 out of 17 positive point evaluations returns via an Internet or WWW connection 3510, “Hello, and your first name” on a display screen of a computer 3511, while a non match returns a negative point evaluation.

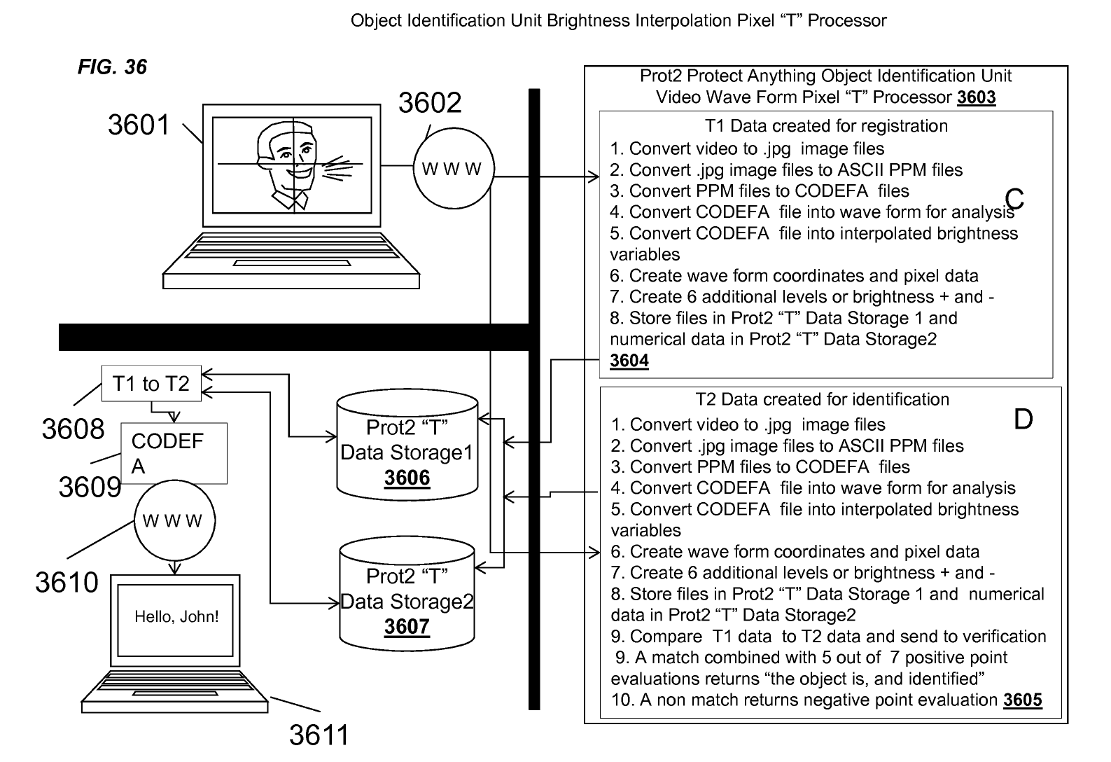

Now referring to FIG. 36, working from a computer or mobile device 3601 and using an Internet or world wide web (WWW) connection 3602, a user using a computer or mobile device 3601, accessing an authentication unit 3603.

The authentication unit 3603 creating data for registration 3604 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; creating 6 additional levels or brightness + and −; storing files in a first data storage 3606 and numerical data in a second data storage 3607.

The authentication unit 3603 creating data for identification 3605 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; creating 6 additional levels or brightness + and −; storing files in a first data storage 3606 and numerical data in a second data storage 3607; comparing T1 data to T2 data in step 3608 and sending it to verification in step 3609. A match combined with 9 out of 17 positive point evaluations returns via an Internet or WWW connection 3610, “Hello, and your first name” on a display screen of a computer 3611, while a non match returns a negative point evaluation.

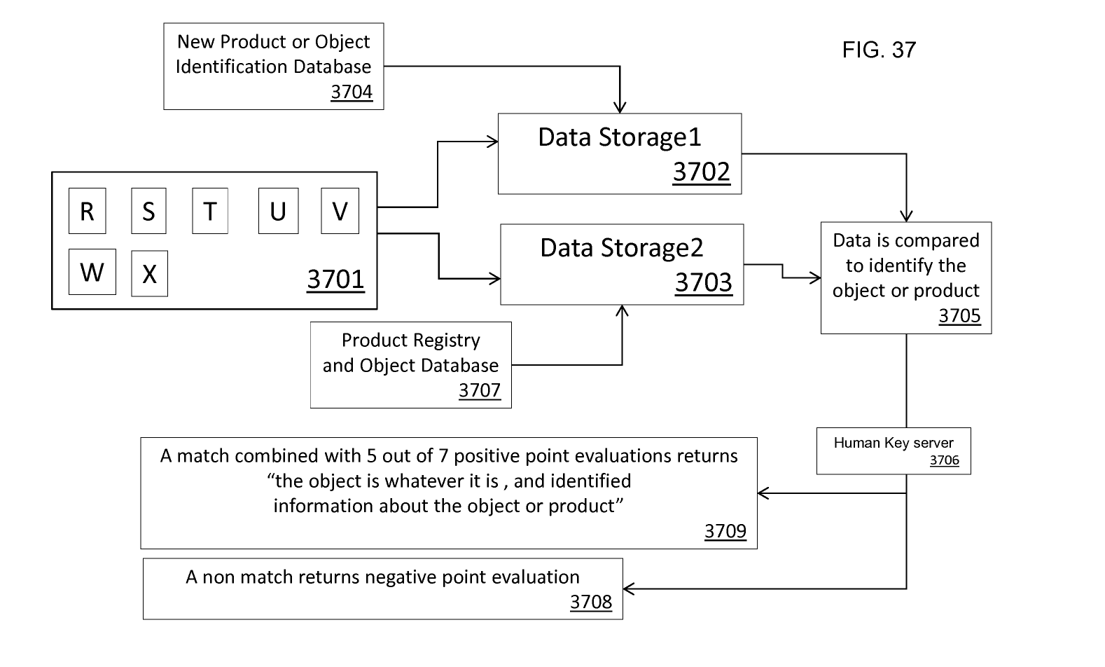

Now referring to FIG. 37, input 3701 is stored in a first data storage 3702 and a second data storage 3703. New product or object identification information is supplied from a database 3704 and combined with the input 3701 in the first data storage 3702 and with product registry and object data 3707 in the second data storage 3703. The data is compared to identify the object or product 3705 and sent to the human key server 3706. A match combined with 5 out of 7 positive point evaluations returns “the object is whatever it is, and identified information about the object or product” 3709. A non match returns negative point evaluation 3708.

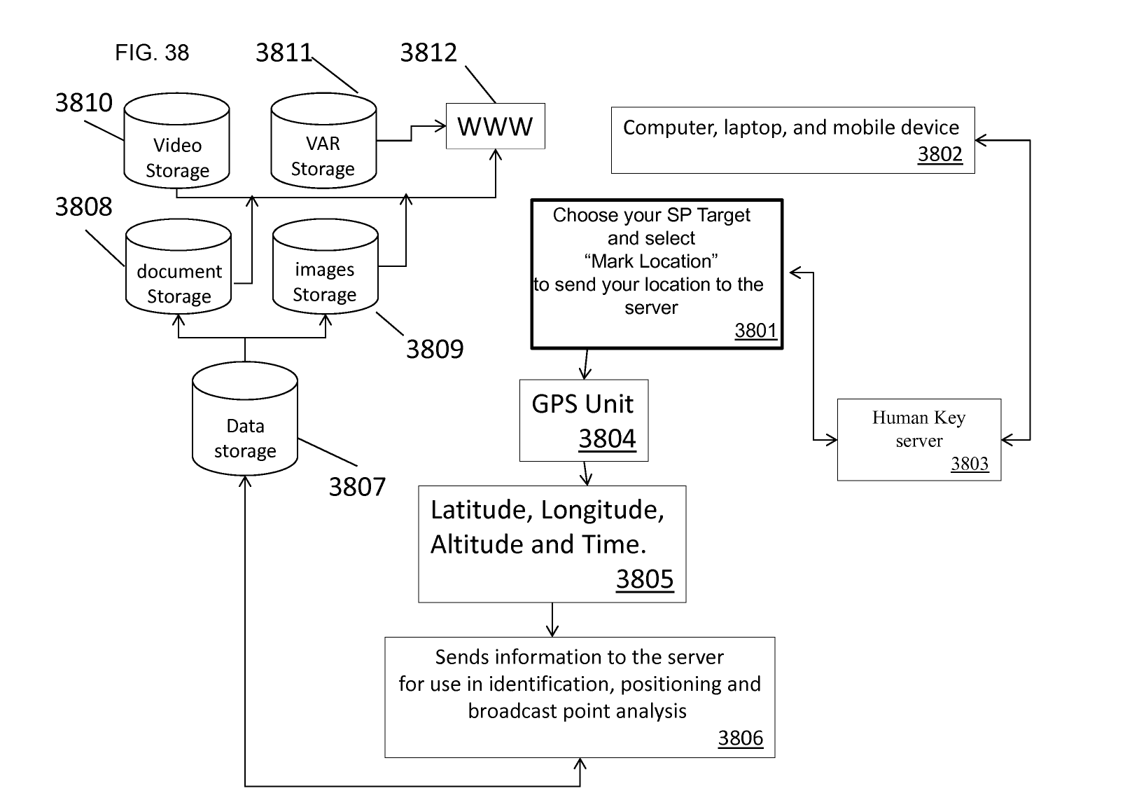

Now referring to FIG. 38, a user marks the spatial point target where they want their content delivered and then selects mark location and the location is identified for the delivery 3801 using a computer laptop or mobile device 3802 authenticated by the human key server 3803. A GPS unit 3804 sends latitude, longitude, altitude, and time data 3805 to the server for use in identification, positioning, and broadcasting point analysis 3806. The information is then sent to a data storage 3807 where it is forwarded on to document storage 3808 and image storage 3809, video storage 3810, and VAR storage 3811 before it is transmitted by the WWW 3812.

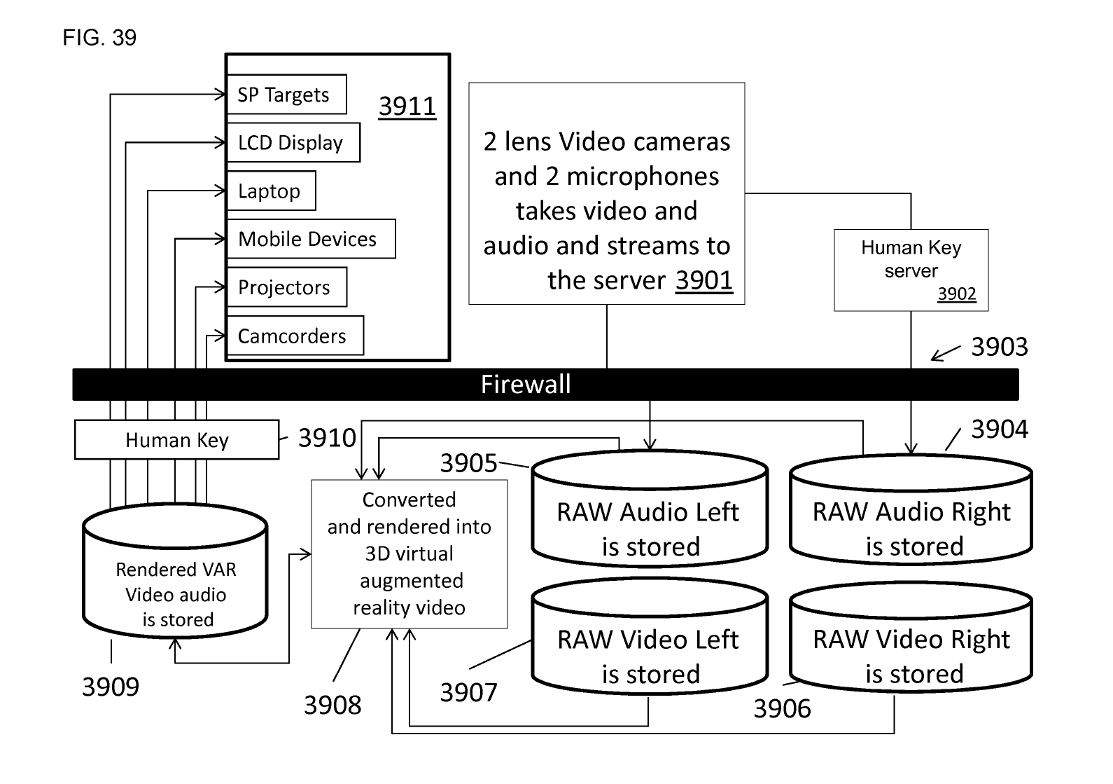

FIG. 39 represents the human key Virtual Augmented Reality System Processor Mechanism in Virtual and Non Virtual Worlds. A 2 lens Video cameras and 2 microphones takes video and audio and streams to the server 3901 the information is then sent to the human key server 3902 and across a firewall 3903 where raw Audio left 3905 and right 3904 is stored in addition to the raw video left 3907 and right 3906. The audio and video is then converted and rendered into 3D virtual augmented reality video 3908 and stored 3909 behind a human key 3910 before delivery back across the firewall 3903 to electronic devices 3911.

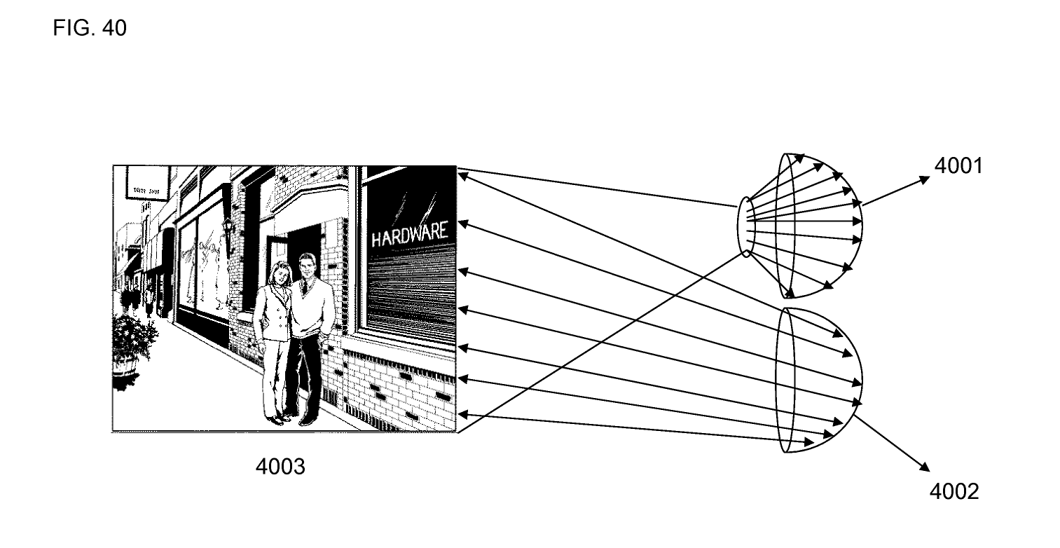

Now referring to FIG. 40, an illumination transformer audio video manager interactive server transmitter (ITAVMIST-IL-UHD) Ultra High Definition Multi Spectrum Camera Mechanism in Virtual and Non Virtual Worlds is shown. When Multi Color spectrum APSL Pixel Processor Data 4001 and Infrared Free Space distance measurement pixel processor Data 4002 are combined into each other it creates an Ultra High Definition file for projection and viewing with multi spectrum color fine pixels as shown by element 4003.

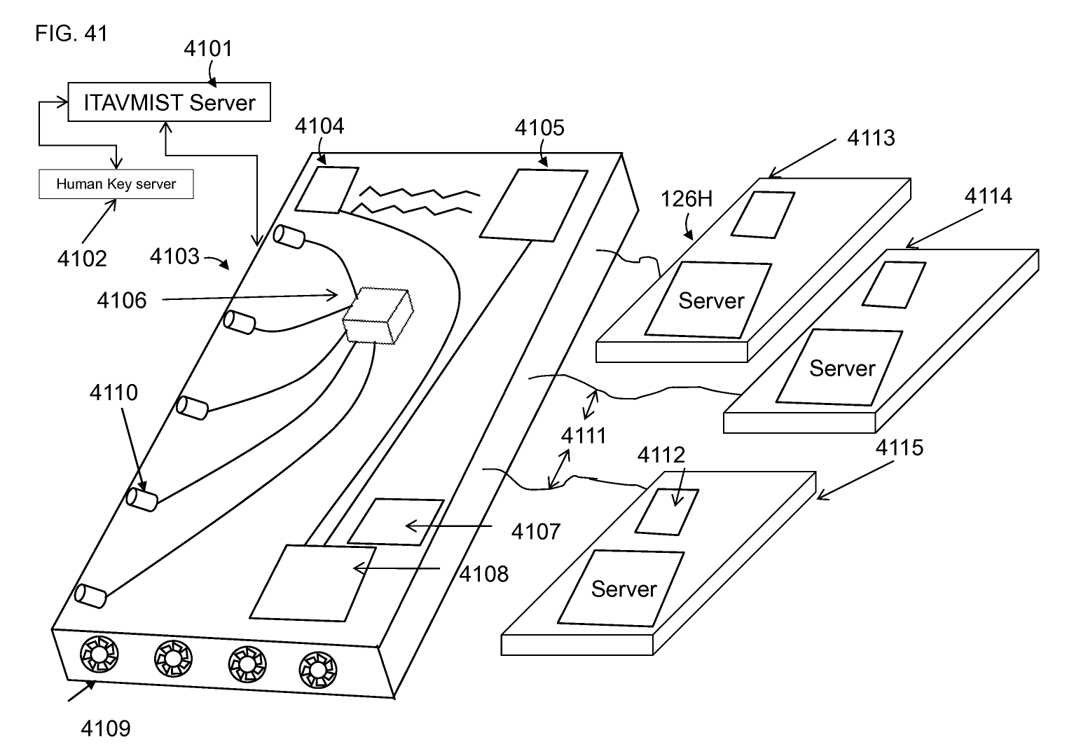

Now referring to FIG. 41, the illumination transformer audio video manager interactive server transmitter (ITAVMIST) connected wireless 4112 or wired 4111 to one or more free standing laser transmitter array devices 4113, 4114, and 4115 in Virtual and Non Virtual Worlds is shown. The ITAVMIST Server 4102 communicates with the human key server 4101 and is comprised of a receiver 4104, transmitter 4105, transformer 4106, router 4107, main process server 4108, vent fans 4109, and mini generators 4110.

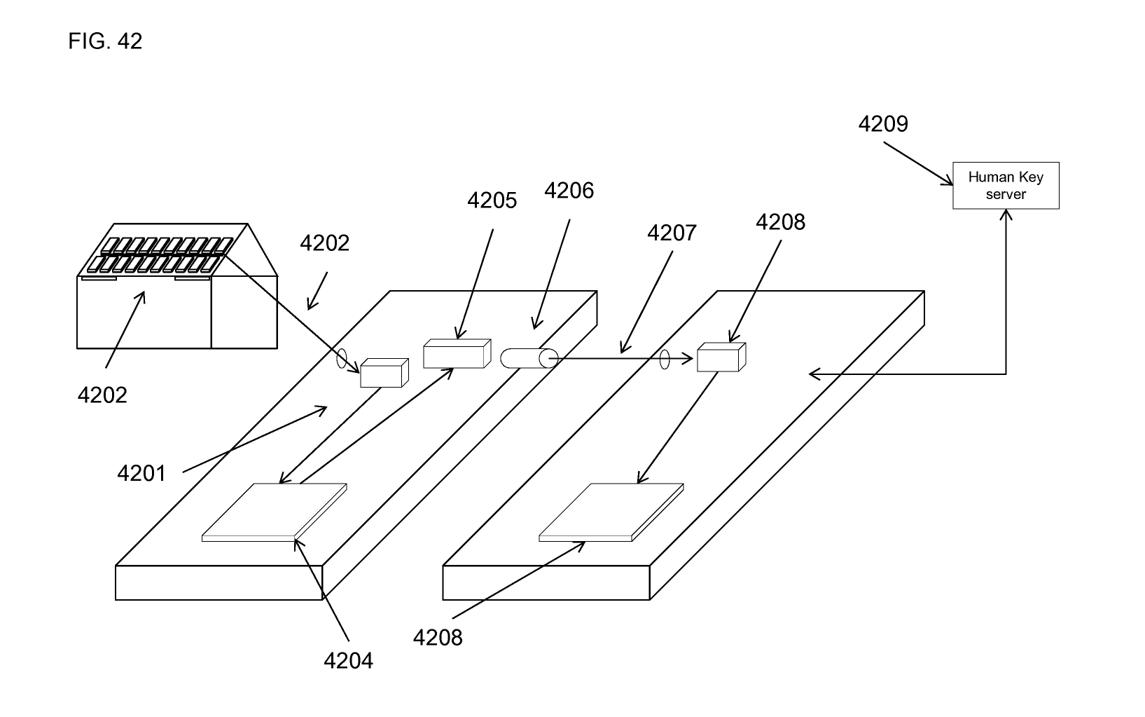

FIG. 42 shows the Laser communication Transceiver Transmission and Receiver Mechanism of the present invention. The laser communications transmission and receiving device is attached to all servers for communication between all servers and devices utilizing infrared, or visible light laser light transmission, in the system for the purpose of providing communication between servers in a community of server clusters, utilizing laser light, by transforming information and data into laser light, with a transmitter modulator device. A receiver 4201 receives laser light 4202 from a neighbors cluster grid 4203 for transformation by a main processor 4204. A transformer 4205 the receives the signal and the transmitter 4206 sends the information via laser light 4207 to a second receiver 4208 which transforms the laser light into information or data to be processed by another main processor 4208 and authentication by the human key server 4209.

Moreover, other implementations of the invention will be apparent to those skilled in the art from consideration of the specification and practice of the invention disclosed herein. Various aspects and components of the described embodiments may be used singly or in any combination in the computerized content filtering system. It is intended that the specification and examples be considered as exemplary only, with a true scope and spirit of the invention being indicated by the following claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. An apparatus for connecting a human key identification to objects and content or identification, tracking, delivery, advertising, and marketing executed by a computer comprising:
an Independent Clearing House Agent (ICHA) server;
a human key server;
the human key server is connected to a translation server and universal virtual world (UVW) server;
a virtual world airport (VWA) server is connected to a development server which in turn communicates with an illumination transformer audio video manager interactive server transmitter (ITAVMIST) which communicates with a Virtual Cash Virtual Currency (VCVC) server.

2. The apparatus of claim 1 further comprising:
a first thin client server hardware device provided for intelligent free roaming;
a second data storage device that interacts with the human key server; and
a server report module;
wherein the first thin client server host hardware device interacts with a first data storage and uses a host server form to gather input from an application development device; and
a doctor exchange input form used by the server report module to publish information to the world wide web (WWW).

3. The apparatus of claim 3 further comprising:
an exchange form that gathers input and sends it to a first thin client server via a portalbot;
a second thin client server that uses a netbot to send human key server information to the first thin client server;
both the first thin client server and second thin client server receiving information from the human key server information;
the human key server information sends and receives information to and from a servers performing a least one of the functions:
a Name Keyword Analyzer Algorithm automatically searching the second thin client server and Drug Criteria Data Storage for input of drug names, company names, peoples names, book names, and idea key names;
a Pre Phrase Analyzer Algorithm Human Semantic Comparison with the second thin client server;
a Post Phrase Analyzer Algorithm Human Semantic Comparison with second thin client server; and
a Form Analyzer Algorithm Human Semantic Comparison with second thin client server.

4. The apparatus of claim 1 further comprising:
a laptop or cam is used to provide input to a first manager server which communicates with a time stamp back up media server and a cluster of storage servers that have access to the human key server and digital fingerprint storage servers for verification;
a digital segmented storage server provides access across a firewall to streaming media servers; and
the streaming media servers are controlled by a manager server that provides output.

5. The apparatus of claim 1 further comprising:
a cam or computer accessing the human key server which in turn accesses a media server which accesses a first video server stream manager which in turn sends information to a time stamp server and certifier which is backed up a stored;
a digital fingerprint validation information is provided by accesses to the first video server stream manager to a digital storage encryption server which validates a digital fingerprint form stored prints and encrypted prints and sends the validation the first video server stream manager which in turn generates a CODEFA number for submission;
the CODEFA number is good for one use then a new number must be retrieved;
a second video streaming server sends information to a computer device which is accessed by any computer to request to unlock, which is verified by the human key server which confirms a payment, user, password, and CODEFA number.

6. The apparatus of claim 5 further comprising:
a computer or cam 701 accessed a manger server which contains a processor for storing information on a time stamp backup media server which connection to a cluster of storage servers;
the time stamp backup media server stores the CODEFA and the cluster storage servers store the human key;
digital fingerprint storage servers and Digital segmented storage servers communicate with the cluster storage servers and provide access across a firewall to streaming media servers;
a server provides human key Video Audio Identification to a manager unit provided with the human key.

7. The apparatus of claim 1 further comprising:
a laptop or mobile device communicates with a human key server; and a second thin client server;
an authentication unit generates a CODEFA and stores it in a first database for transmission to a first thin client server;
the first thin client server sends and receives information between a human semantics generator unit the world wide web and a second computer or mobile device;
a variable criteria data storage provides information to the human semantics generator unit, second computer or mobile device, and a second human semantics processor for transmission to a second thin client server and second data storage.

8. The apparatus of claim 7 further comprising:
the second thin client server transmits information between a second data storage, a report module, a first thin client server, and a human key server;
CODEFA is transmitted two the second client server and the world wide web;
the report module generates reports for transmission or print out via the world wide web;
the first thin client server transmits information to and from a first data storage, the report module, the second thin client server, and to a host server via the human key server for verification.

9. The apparatus of claim 8 further comprising:
a hosting server form transmitting information verified by the human key server via a portalbot to a first thin client server and a second thin client server via a netbot;
the thin client servers share information between at least one form the group:
a Name Keyword Analyzer Algorithm that automatically searches and subject Criteria Data Storage for input of names, company names, peoples names, book names, and idea key names;
a Pre Phrase Analyzer Algorithm for Human Semantic comparison between clients;
a Post Phrase Analyzer Algorithm for Human Semantic comparison between clients; and
a Form Analyzer Algorithm for Human Semantic comparison between clients which then transmits the output to the report module.

10. The apparatus of claim 9 further comprising:
a computer laptop or mobile device connects to a first email thin client server and data storage, and a second human semantics processor and variable data storage for submitting input;
a first email human key authentication unit generates a CODEFA for storage and transmission to a first human semantics generator unit and a second email thin client server which confirms identification using the human key server and delivers email to an email retriever's computer or mobile device or via the world wide web.

11. The apparatus of claim 10 further comprising:
an email sender submits an email via the WWW to a human key server which then uses an email human key authentication unit to generate a CODEFA for deliver, which the email to an intelligent server device which stores the email in first data storage, variable criteria storage, and human semantics processor;
the email is passed across a firewall from the first data storage to a second data storage, where a second intelligent email server authenticates the email with the human key server, CODEFA, and email human key authentication unit via the WWW before deliver to the email receiver's computing device.

12. The apparatus of claim 11 further comprising:
the second thin client server transmits information between a second data storage, a report module, a first thin client server, and a human key server;
CODEFA is transmitted two the second client server and the world wide web;
the report module generates reports for transmission or print out via the world wide web;
the first thin client server transmits information to and from a first data storage, the report module, the second thin client server, and to a host server via the human key server for verification.

13. The apparatus of claim 1, further comprising:
a mobile device consisting of a camera for capturing and recording video and audio data;
a server for receiving video streamed to it by the mobile device for sign-up or sign-in;
working from a computer or mobile device and using an Internet connection;
accessing an authentication unit
the authentication unit creating data for registration
the authentication unit also creating identification data; and
sending to verification; a match combined with 9 out of 17 positive point evaluations returns, via an Internet connection to the mobile device;
wherein
the authentication unit creating data for registration by:
converting video to .jpg image files;
converting .jpg image files to ASCII PPM files;
converting PPM files to CODEFA files;
converting CODEFA files into wave form for analysis;
converting CODEFA files into interpolated brightness variables;
creating wave form coordinates and pixel data;
storing files in a first data storage and numerical data in a second data storage location;
the authentication unit creating identification data by:
converting video to .jpg image files;
converting .jpg image files to ASCII PPM files;
converting PPM files to CODEFA files;
converting CODEFA files into wave form for analysis;
converting CODEFA files into interpolated brightness variables;
creating wave form coordinates and pixel data;
storing files in a first data storage and numerical data in a second data storage and comparing the first data to the second date using a Computer Object De-Encryption Encryption File Algorithm (CODEFA); and
sending to verification; a match combined with 9 out of 17 positive point evaluations returns, via an Internet connection to the mobile device.

14. The apparatus of claim 13, wherein
the authentication unit creating data for registration by:
extracting audio from video and converting to Wave form;
creating a point grid for analysis;
creating a form coordinates;
creating numerical reference points;
converting data into interpolated volume variables;
storing wave form coordinates and volume data; and
storing files in a first data storage and numerical data in a second data storage;
the authentication unit also creating data for identification by:
extracting audio from video and converting to Wave form;
creating point grid for analysis; creating wave form coordinates creating numerical reference points;
converting data into interpolated volume variables;
storing form coordinates and volume data; storing files in a first data storage and numerical data in a second data storage; and
comparing data stored in the databases in step and sending to verification by CODEFA.

15. The apparatus of claim 13, wherein
the authentication unit creating data for registration by:
extracting 24 images at beginning of audio;
extracting 24 images at 2 second mark of audio start;
extracting 24 images backward at end of audio stop;
converting files into wave form for analysis;
converting files into interpolated brightness variables;
creating wave form coordinates and pixel data; and
storing files in a first data storage and numerical data in a second data storage;
the authentication unit also creating data for identification by:
extracting 24 images at beginning of audio;
extracting 24 images at 2 second mark of audio start;
extracting 24 images backward at end of audio stop;
converging into wave form for analysis; converting files into interpolated brightness variables;
creating wave form coordinates and pixel data;
storing file in a first data storage and numerical data in a second data storage; and
comparing data stored in the databases in step and sending to verification by CODEFA.

16. The apparatus of claim 2, wherein
the authentication unit creating data for registration by:
extracting form the video 3 image files at random times; converting .jpg image files to ASCII PPM files;
converting PPM files to CODEFA files;
converting CODEFA file into wave form for analysis; converting CODEFA file into interpolated brightness variables;
creating wave form coordinates and pixel data; and storing files in a first data storage and numerical data in a second data storage;
the authentication unit also creating data for identification by:
extracting from video three image files at random times;
converting .jpg image files to ASCII PPM files;
converting PPM files to CODEFA files;
converting CODEFA files into wave form for analysis;
converting CODEFA files into interpolated brightness variables;
creating wave form coordinates and pixel data; storing files in a first data storage and numerical data in a second data storage; and
comparing data stored in the databases and sending to verification by CODEFA.

17. The apparatus of claim 2, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA files into interpolated brightness variables;
creating wave form coordinates and pixel data; creating 6 additional levels or brightness + and −;
storing files in a first data storage and numerical data in a second data storage;
the authentication unit also creating data for identification by:
converting video to .jpg image files;
converting.jpg image files to ASCII PPM files;
converting PPM files to CODEFA files;
converting CODEFA file into wave form for analysis; converting CODEFA files into interpolated brightness variables;
creating wave form coordinates and pixel data;
creating six additional levels or brightness + and −;
storing files in a first data storage and numerical data in a second data storage;
comparing data stored in the databases and sending to verification by CODEFA.

18. The apparatus of claim 2, wherein
the authentication unit creating data for registration by:
verifying video and audio are stored;
processing video and audio into CODEFA;
during verification state Video and Audio spatial point is recorded from microphone and camera lenses;
storing files in a first data storage and numerical data in a second data storage;
the authentication unit also creating data for identification by:
verifying video and audio are stored;
processing video and audio into CODEFA;
During verification state Video and Audio SP spatial point is recorded from microphone and camera lenses; storing files in a first data storage and numerical data in a second data storage;
During identification CODEFA Registration SP data is compared to CODEFA Identification SP data to see if it matches;
comparing data and send to verification; and
if match data is stored as + data for learning;
if no match data is stored as − data for learning and the video data is analyzed for a match of who the user really is, and if identified;
notifies user by email questioning the failed identification.

19. The apparatus of claim 2, wherein
the authentication unit creating data for registration by:
extracting audio from video and converting to Wave form;
creating point grid for analysis; creating wave form coordinates; creating numerical reference points;
converting data into interpolated volume variables; storing wave form coordinates and volume data from audio phrase begin point to end point; and storing files in a first data storage and numerical data in a second data storage;
the authentication unit also creating data for identification by:
extracting audio from video and converting to Wave form;
creating point grid for analysis; creating wave form coordinates;
creating numerical reference points; c
converting data into interpolated volume variables;
storing wave form coordinates and volume data from audio phrase begin point to end point; and
storing files in a first data storage and numerical data in a second data storage; comparing data and sending to verification by CODEFA.

20. The apparatus of claim 2, wherein
the authentication unit creating data for registration by:
receiving processor data during registration;
receiving processor time of day related to registration;
receiving typed phrase during registration;
receiving audio file of phrase spoken at CODEFA during registration;
converting CODEFA file into interpolated volume variables with SP Target data embedded;
creating wave form coordinates and pixel data;
storing files in a first data storage and numerical data in a second data storage;
the authentication unit also creating data for identification by:
receiving processor data during registration;
receiving processor time of day related to registration;
receiving typed phrase during registration;
receiving audio file of phrase spoken at CODEFA during registration;
converting CODEFA files into interpolated volume variables with SP Target data embedded;
creating wave form coordinates and pixel data; storing files in a first data storage and numerical data in a second data storage;
comparing data and sending to verification by CODEFA.

21. The apparatus of claim 2, wherein
the authentication unit creating data for registration by:
converting dual cam video to .jpg image files with SP Target of each cam embedded;
converting .jpg image files to ASCII PPM files;
converting PPM files to CODEFA files;
converting CODEFA files into wave form for analysis; converting CODEFA files into interpolated brightness variables;
creating wave form coordinates and pixel data; storing files in a first data storage and numerical data in a second data storage;
the authentication unit also creating data for identification by:
converting dual cam video to .jpg image files with SP Target of each cam embedded;
converting .jpg image files to ASCII PPM files;
converting PPM files to CODEFA files;
converting CODEFA files into wave form for analysis; converting CODEFA files into interpolated brightness variables;
creating wave form coordinates and pixel data;
storing files in a first data storage and numerical data in a second data storage;
comparing data and sending to verification by CODEFA.

22. The apparatus of claim 2, wherein
The authentication unit creating data for registration Automatic Object Identification, views background compared with foreground and attaches box around moving object with 16 pixels distance around the edge, locks on, gets image for beginning of processing then:
converting video to .jpg image files;
converting .jpg image files to ASCII PPM files;
converting PPM files to CODEFA files;
converting CODEFA file into wave form for analysis;
converting CODEFA file into interpolated brightness variables; creating wave form coordinates and pixel data; and storing files in a first data storage and numerical data in a second data storage;
the authentication unit also creating data for identification by Automatic Object Identification then:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
comparing data and sending to verification by CODEFA.

23. The apparatus of claim 2, wherein
the authentication unit creating data for registration by:
using an audio phrase distance device comprised of on the phone or device;
sending data back to the main server for evaluation and decision to determine distance to object using sound and infrared data;
converting variation calculated with audio phrase distance and distance data to object data;
storing files in a first data storage and numerical data in a second data storage and audio phrase distance data in a third data storage;
the authentication unit also creating data for identification by:
using an audio phrase distance device to determine Distance to object using sound and infrared data;
converting variation calculated with audio phrase distance and distance data to object data;
storing files in a first data storage, numerical data in a second data storage, and audio phrase distance data in a third data storage;
using stored values for comparison with audio data; and
determining identification at different distances from microphone.

24. The apparatus of claim 2, wherein
the authentication unit creating data for registration by:
converting 3D multiple cam video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
the authentication unit also creating data for identification by:
converting dual cam video to .jpg image files with SP Target of each cam embedded;
converting .jpg image files to ASCII PPM files;
converting PPM files to CODEFA files;
converting CODEFA files into wave form for analysis; c converting CODEFA files into interpolated brightness variables;
creating wave form coordinates and pixel data; storing files in a first data storage and numerical data in a second data storage;
comparing 3D differences and store in 3D data storage;
comparing data in a first data storage and numerical data in a second data storage;
comparing the data and sending to verification.

25. The apparatus of claim 2, wherein
the authentication unit creating data for registration by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit also creating data for identification by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage 1606 and numerical data in a second data storage; and
comparing data stored in the databases and send to verification.

26. The apparatus of claim 2, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA files into interpolated brightness variables;
creating wave form coordinates and pixel data PCB;
storing files in a first data storage land numerical data in a second data storage;
the authentication unit also creating data for identification by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data PCB;
storing files in a first data storage and numerical data in a second data storage;
comparing data stored in the databases using CODEFA.

27. The apparatus of claim 2, wherein
the authentication unit creating data for registration by:
converting audio from two stereo microphones to data;
converting audio data and input into database;
analyze and compare left data from right data;
storing files in a first data storage and numerical data in a second data storage;
the authentication unit creating data for identification by:
converting audio from two stereo microphones to data;
converting audio data and input into databases;
analyzing and comparing left date from right data;
storing files in a first data storage and numerical data in a second data storage;
comparing data stored in the databases in step using CODEFA.

28. The apparatus of claim 2, wherein
the authentication unit creating data for registration by:
converting video to .jpg image files;
converting file into interpolated brightness variables; converting .jpg image files to vector files;
converting Vector Files to line art; overlaying Line art on to grid form for analysis; creating grid form coordinates and pixel data PCB;
storing files in a first data storage and numerical data in a second data storage;
the authentication unit creating data for identification by:
converting video to .jpg image files;
converting file into interpolated brightness variables;
converting .jpg image files to Vector files; converting Vector Files to line art; overlaying Line art on to grid form for analysis;
creating grid form coordinates and pixel data PCB;
storing files in a first data storage and numerical data in a second data storage;
comparing data in step using CODEFA.

29. The apparatus of claim 2, wherein
the authentication unit creating data for registration by:
converting video to .jpg image files;
converting file into interpolated brightness variables;
converting .jpg image files to vector files;
converting vector files to line art;
overlaying line art on to grid form for analysis;
creating grid form coordinates and pixel data PCB; and
storing files in a first data storage and numerical data in a second data storage;
the authentication unit creating data for identification by:
converting video to .jpg image files;
converting file into interpolated brightness variables;
converting .jpg image files to Vector files;
converting Vector Files to line art;
overlaying line art on to grid form for analysis;
creating grid form coordinates and pixel data PCB;
storing files in a first data storage and numerical data in a second data storage;
comparing data stored in the databases using CODEFA.

30. The apparatus of claim 2, wherein
the authentication unit creating data for registration by:
converting 3D multiple cam video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit creating data for identification by:
converting dual cam video to .jpg image files with SP Target of each cam embedded;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage and numerical data in a second data storage;
comparing 3D differences and store in 3D data storage;
comparing data and send to verification using CODEFA.

31. The apparatus of claim 2, wherein
The authentication unit creating data for registration by:
converting video to .jpg image files in grayscale;
converting .jpg image files to ASCII PPM files;
converting PPM files to CODEFA files;
converting CODEFA files into wave form for analysis;
converting CODEFA files into interpolated brightness variables;
creating wave form coordinates and pixel data;
storing files in a first data storage and numerical data in a second data storage;
the authentication unit creating data for identification by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage and numerical data in a second data storage;
comparing V1 data to V2 data sending to verification using CODEFA.

32. The apparatus of claim 2, wherein
the authentication unit creating data for registration by:
converting dual cam video to .jpg image files with SP Target of each cam embedded;
converting .jpg image files to ASCII PPM files;
converting PPM files to CODEFA files;
converting CODEFA files into wave form for analysis;
converting CODEFA files into interpolated brightness variables;
creating wave form coordinates and pixel data; storing files in a first data storage and numerical data in a second data storage;
the authentication unit creating data for identification by:
converting dual cam video to .jpg image files with SP Target of each cam embedded;
converting .jpg image files to ASCII PPM files;
converting PPM files to CODEFA files;
converting CODEFA files into wave form for analysis;
converting CODEFA files into interpolated brightness variables;
creating wave form coordinates and pixel data;
storing files in a first data storage and numerical data in a second data storage;
comparing data in step and sending to verification using CODEFA.

33. The apparatus of claim 2, wherein
the authentication unit creating data for registration by Automatic Object Identification, views background compared with foreground and attaches box around moving object with 16 pixels distance around the edge, locks on, gets image for beginning of processing then:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit creating data for identification by Automatic Object Identification then:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
comparing data stored in the databases and sending to verification via CODEFA.

34. The apparatus of claim 2, wherein
the authentication unit creating data for registration by:
extracting from video 3 image files at random times;
converting .jpg image files to ASCII PPM files;
converting PPM files to CODEFA files;
converting CODEFA files into wave form for analysis;
converting CODEFA files into interpolated brightness variables;
creating wave form coordinates and pixel data; and
storing files in a first data storage and numerical data in a second data storage;
the authentication unit creating data for identification by:
extracting from video 3 image files at random times;
converting .jpg image files to ASCII PPM files;
converting PPM files to CODEFA files;
converting CODEFA file into wave form for analysis;
converting CODEFA files into interpolated brightness variables;
creating wave form coordinates and pixel data;
storing files in a first data storage and numerical data in a second data storage;
comparing data stored in the databases and sending to verification using CODEFA.

35. The apparatus of claim 2, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; creating 6 additional levels or brightness + and −;
storing files in a first data storage and numerical data in a second data storage;
the authentication unit creating data for identification by:
converting video to .jpg image files;
converting .jpg image files to ASCII PPM files; converting PPM files to CODEFA files;
converting CODEFA file into wave form for analysis; converting CODEFA file into interpolated brightness variables;
creating wave form coordinates and pixel data; creating 6 additional levels or brightness + and −;
storing files in a first data storage and numerical data in a second data storage;
comparing stored data and sending it to verification.

36. The apparatus of claim 2, wherein input is stored in a first data storage and a second data storage;
new product or object identification information is supplied from a database 3 and combined with the input in the first data storage and with product registry and object data in the second data storage;
the data is compared to identify the object or product and sent to the human key server;
a match combined with 5 out of 7 positive point evaluations returns identified information about the object or product; and
a non match returns negative point evaluation.

37. The apparatus of claim 2, wherein
a user marks the spatial point target where they want their content delivered and then selects mark location and the location is identified for the delivery using a computer laptop or mobile device authenticated by the human key server;
a GPS unit sends latitude, longitude, altitude, and time data to the server for use in identification, positioning, and broadcasting point analysis;
the information is then sent to a data storage where it is forwarded on to document storage and image storage, video storage, and VAR storage before it is transmitted by the WWW.

38. The apparatus of claim 2, wherein
a two lens Video cameras and 2 microphones takes video and audio and streams to the server the information is then sent to the human key server and across a firewall where raw Audio left and right is stored in addition to the raw video left and right;
the audio and video is then converted and rendered into 3D virtual augmented reality video and stored behind a human key before delivery back across the firewall to electronic devices.

39. The apparatus of claim 38, further comprising
an illumination transformer audio video manager interactive server transmitter (ITAVMIST-IL-UHD) Ultra High Definition Multi Spectrum Camera Mechanism;
a Multi Color spectrum APSL Pixel Processor Data 4001 and Infrared Free Space distance measurement pixel processor Data are combined into each other to creates an Ultra High Definition file for projection and viewing with multi spectrum color fine pixels.

40. The apparatus of claim 40, wherein
the illumination transformer audio video manager interactive server transmitter (ITAVMIST) is connected wireless or wired to one or more free standing laser transmitter array devices;
the ITAVMIST Server communicates with the human key server and is comprised of a receiver, transmitter, transformer, router, main process server, vent fans, and mini generators.

41. The apparatus of claim 40, wherein
the laser communications transmission and receiving device is attached to servers for communication between all servers and devices utilizing infrared, or visible light laser light transmission, in the system for the purpose of providing communication between servers in a community of server clusters, utilizing laser light, by transforming information and data into laser light, with a transmitter modulator device;
a receiver receives laser light from a neighbors cluster grid for transformation by a main processor;
a transformer receives the signal and the transmitter sends the information via laser light to a second receiver;
the second receiver transforms the laser light into information or data to be processed by another main processor and authentication by the human key server.
